(19) United States
(12) Patent Application Publication
(10) Pub. No.: US 2018/0122056 A1
(43) Pub. Date: May 3, 2018

(54) IMAGE PROCESSING DEVICE, IMAGE PROCESSING METHOD, PROGRAM, RECORDING MEDIUM RECORDING THE PROGRAM, IMAGE CAPTURE DEVICE AND IMAGE RECORDING/REPRODUCTION DEVICE

(71) Applicant: MITSUBISHI ELECTRIC CORPORATION, Tokyo (JP)

(72) Inventors: Kohei KURIHARA, Tokyo (JP); Narihiro MATOBA, Tokyo (JP)

(73) Assignee: MITSUBISHI ELECTRIC CORPORATION, Tokyo (JP)

(21) Appl. No.: 15/565,071

(22) PCT Filed: Feb. 16, 2016
(86) PCT No.: PCT/JP2016/054359

§ 371 Date: Oct. 6, 2017

(30) Foreign Application Priority Data
May 22, 2015 (JP) 2015-104848

(51) Int. Cl. G06T 5/00; G06T 7/90

(52) U.S. Cl. CPC G06T 5/008; G06T 5/20; G06T 7/90

(57) ABSTRACT

An image processing device (100) includes: a reduction processor (1) that generates reduced image data (D1) from input image data (DIN); a dark channel calculator (2) that performs a calculation which determines a dark channel value (D2) in a local region throughout a reduced image by changing a position of the local region, and outputs a plurality of dark channel values as a plurality of first dark channel values (D2); a map resolution enhancement processor (3) that performs a process of enhancing resolution of a first dark channel map constituted by the plurality of first dark channel values (D2), thereby generating a second dark channel map constituted by a plurality of second dark channel values (D3); and a contrast corrector (4) that generates corrected image data (DOUT) on the basis of the second dark channel map and the reduced image data (D1).

### TECHNICAL FIELD

The present invention relates to an image processing device and an image processing method that perform a process of removing haze from an input image (a captured image) based on image data generated by capturing an image with a camera, thereby generating image data of a haze corrected image without the haze (a haze-free image) (corrected image data). The present invention also relates to a program which is applied to the image processing device or the image processing method, a recording medium in which the program is recorded, an image capture device and an image recording/reproduction device.

### BACKGROUND ART

As factors which cause deterioration in clarity of a captured image obtained by capturing an image with a camera, there are aerosols and the like; aerosols include haze, fog, mist, snow, smoke, smog and dust. In the present application, these are collectively called ‘haze’. In a captured image (a haze image) which is obtained by capturing an image of a subject with a camera in an environment where haze exists, as the density of the haze increases, the contrast decreases and the recognizability and visibility of the subject deteriorate. In order to improve such deterioration in image quality due to haze, haze correction techniques for removing haze from a haze image to generate image data of a haze-free image (corrected image data) have been proposed.

In such haze correction techniques, a method for estimating a transmittance (transmission) in a captured image and correcting contrast in accordance with the estimated transmittance is effective. For example, Non-Patent Document 1 proposes, as a method for correcting the contrast, a method based on Dark Channel Prior. The dark channel prior is a statistical law obtained from images of open-air nature in which no haze exists. The dark channel prior is a law stating that when light intensity of a plurality of color channels (a red channel, a green channel and a blue channel, i.e., R channel, G channel and B channel) in a local region of an image of open-air nature other than the sky is examined for each of the color channels, a minimum value of the light intensity of at least one color channel of the plurality of color channels in the local region is an extremely small value (a value close to zero, in general). The smallest value of minimum values of the light intensity of the plurality of color channels (i.e., R channel, G channel and B channel) (i.e., R-channel minimum value, G-channel minimum value and B-channel minimum value) in the local region is called a dark channel or a dark channel value. According to the dark channel prior, by calculating a dark channel value in each local region from image data generated by capturing an image with a camera, it is possible to estimate a map (a transmission map) constituted by a plurality of transmittances of respective pixels in the captured image. Then, by using the estimated transmission map, it is possible to perform image processing for generating corrected image data as image data of a haze-free image, from the data of the captured image (e.g., a haze image).

As shown in Non-Patent Document 1, a model for generating a captured image (e.g., a haze image) is represented by the following equation (1).

I(X)=J(X)·t(X)+A·(1-t(X)) equation (1)

In equation (1), X denotes a pixel position which can be expressed by coordinates (x, y) in a two-dimensional Cartesian coordinate system; I(X) denotes light intensity in the pixel position X in the captured image (e.g., the haze image); J(X) denotes light intensity in the pixel position X in a haze corrected image (a haze-free image); t(X) denotes a transmittance in the pixel position X and satisfies 0<t(X)<1; and A denotes an airglow parameter which is a constant value (a coefficient).

In order to determine J (X) from equation (1), it is necessary to estimate the transmittance t (X) and the airglow parameter A. A dark channel value J_{dark} (X) in a certain local region with respect to J (X) is represented by the following equation (2).

$${J}_{dark} ( X ) = {min}_{C ∈ \{ R , G , B \}} ( {min}_{Y ∈ Ω ( X )} ( {J}_{C} ( Y ) ) ) \qquad equation ( 2 )$$

In equation (2), Q(X) denotes the local region including the pixel position X (centered in the pixel position X, for example) in the captured image; J_{C} (Y) denotes light intensity in a pixel position Y in the local region Ω (X) of the R channel, G channel and B channel of the haze corrected image. That is, J_{R} (Y) denotes light intensity in the pixel position Y in the local region Ω (X) of the R channel of the haze corrected image; J_{G} (Y) denotes light intensity in the pixel position Y in the local region Ω (X) of the G channel of the haze corrected image; J_{B} (Y) denotes light intensity in the pixel position Y in the local region Ω (X) of the B channel. min (J_{C} (Y)) denotes a minimum value of J_{C} (Y) in the local region Q (X). min(min(J_{C} (Y))) denotes a minimum value of min(J_{R} (Y)) of the R channel, min(J_{G} (Y)) of the G channel and min(J_{B} (Y)) of the B channel.

According to the dark channel prior, it is known that the dark channel value J_{dark} (X) in the local region Ω (X) in the haze corrected image which is an image where no haze exists is an extremely small value (a value close to zero). However, the higher the density of haze becomes, the larger a dark channel value J_{dark} (X) in the haze image is. Accordingly, on the basis of a dark channel map constituted by a plurality of dark channel values J_{dark} (X), it is possible to estimate a transmission map constituted by a plurality of transmittances t (X) in the captured image.

By transforming equation (1), the following equation (3) is obtained.

$$\frac{{I}_{C} ( X )}{{A}_{C}} = \frac{{J}_{C} ( X )}{{A}_{C}} \cdot t ( X ) + 1 - t ( X ) \qquad equation ( 3 )$$

Here, I_{C} (X) denotes light intensity in the pixel position X of the R channel, G channel and B channel of the captured image; J_{C} (X) denotes light intensity in the pixel position X of the R channel, G channel and B channel of the haze corrected image; Ac denotes an airglow parameter of each of the R channel, G channel and B channel (a constant value in each of the color channels).

From equation (3), the following equation (4) is obtained.

$${min}_{C ∈ \{ R , G , B \}} ( {min}_{Y ∈ Ω ( X )} ( \frac{{I}_{C} ( Y )}{{A}_{C}} ) ) = {min}_{C ∈ \{ R , G , B \}} ( {min}_{Y ∈ Ω ( X )} ( \frac{{J}_{C} ( Y )}{{A}_{C}} ) ) \cdot t ( X ) + 1 - t ( X ) \qquad equation ( 4 )$$

In equation (4), since min(J_{C} (Y)) in one of the color channels is a value close to zero, the first term on the right side of equation (4), that is,

$${min}_{C ∈ \{ R , G , B \}} ( {min}_{Y ∈ Ω ( X )} ( \frac{{J}_{C} ( Y )}{{A}_{C}} ) )$$

can be approximated by a value zero. Thus, equation (4) can be expressed as the following equation (5).

$${min}_{C ∈ \{ R , G , B \}} ( {min}_{Y ∈ Ω ( X )} ( \frac{{I}_{C} ( Y )}{{A}_{C}} ) ) = 1 - t ( X ) \qquad equation ( 5 )$$

According to equation (5), by entering (I_{C} (X)/A_{C}) as an input in the equation, the value on the left side of equation (5), that is, the dark channel value J_{dark} (X) is determined, and thereby the transmittance t (X) can be estimated. On the basis of a map (i.e., a corrected transmission map) of corrected transmittances t′(X) which are the transmittances obtained by entering (I_{C} (X)/A_{C}) as an input, the light intensity I (X) in the captured image data can be corrected. By replacing the transmittance t (X) in equation (1) with the corrected transmittance t′(X), the following equation (6) can be obtained.

$$J ( X ) = \frac{I ( X ) - A}{{t}^{′} ( X )} + A \qquad equation ( 6 )$$

In a case where a minimum value of the denominator of the first term on the right side of equation (6) is defined as a positive constant t0 indicating the lowest transmittance, equation (6) is expressed as the following equation (7).

$$J ( X ) = \frac{I ( X ) - A}{max ( {t}^{′} ( X ) , t 0 )} + A \qquad equation ( 7 )$$

where max(t′ (X), t0) is a larger value of t′ (X) and t0.

FIGS. 1(a) to 1(c) are diagrams for explaining the haze correction technique of Non-Patent Document 1. FIG. 1(a) shows a picture cited from FIG. 9 of Non-Patent Document 1 with the addition of an explanation; FIG. 1(c) shows a picture obtained by performing image processing on the basis of FIG. 1(a). From equation (7), a transmission map as shown in FIG. 1(b) is estimated from a haze image (captured image) as shown in FIG.1(a) and a corrected image as shown in FIG. 1(c) can be obtained. FIG. 1(b) illustrates that the deeper the color of a region (the darker a region) is, the lower the transmittance is (the closer the transmittance is to zero). However, in accordance with the size of a local region set at a time of the calculation of the dark channel value J_{dark} (X), a block effect is caused. The block effect has an influence on the transmission map shown in FIG. 1(b), and it causes a white outline called a halo in the vicinity of a boundary line in the haze-free image shown in FIG. 1(c).

In the technique proposed in Non-Patent Document 1, in order to optimize a dark channel value for a haze image which is a captured image, a resolution enhancement process (it is defined here as resolution enhancement that an edge is matched with an input image to a greater degree) based on a matching model is performed.

The technique proposed in Non-Patent Document 2 proposes a guided filter that performs an edge-preserving smoothing process on a dark channel value by using a haze image as a guide image, in order to enhance the resolution of the dark channel value.

The technique proposed in Patent Document 1 separates a regular dark channel value (sparse dark channel) in which the size of a local region is large into a variable region and an invariable region, generates a dark channel (dense dark channel) in which the size of a local region is reduced when a dark channel is calculated in accordance with the variable region and the invariable region, combines the generated dark channel with the sparse dark channel, and thus estimates a high-resolution transmission map.

### PRIOR ART REFERENCES

### Non-patent Documents

Non-Patent Document 1: Kaiming He, Jian Sun and Xiaoou Tang; “Single Image Haze Removal Using Dark Channel Prior”; 2009; IEEE pp. 1956-1963

Non-Patent Document 2: Kaiming He, Jian Sun and Xiaoou Tang; “Guided Image Filtering”; ECCV 2010

### Patent Document

Patent Document 1: Japanese Patent Application Publication No. 2013-156983 (pp. 11-12)

### SUMMARY OF THE INVENTION

### Problem to be Solved by the Invention

However, it is necessary for the dark channel value estimation method in Non-Patent Document 1 to set a local region for each pixel in each color channel of a haze image and determine a minimum value in each of the set local regions. The size of the local region needs to be a certain size or larger, in consideration of noise tolerance. Hence the dark channel value estimation method in Non-Patent Document 1 has a problem that a computation amount becomes large.

The guided filter in Non-Patent Document 2 needs setting a window for each pixel and a computation for solving a linear model for each window with respect to a guide image and a target image for a filtering process, hence there is a problem that a computation amount becomes large.

Patent Document 1 needs, for performing the process for separating a dark channel into a variable region and an invariable region, a frame memory capable of holding image data of a plurality of frames, and thus there is a problem that a large-capacity frame memory is required.

The present invention is made to solve the problems of the conventional arts, and an object of the present invention is to provide an image processing device and an image processing method capable of obtaining a haze-free image with high quality from an input image, with a small computation amount and without requiring a large-capacity frame memory. Another object of the present invention is to provide a program which is applied to the image processing device or the image processing method, a recording medium in which this is recorded, an image capture device and an image recording/reproduction device.

### Means for Solving the Problem

An image processing device according to an aspect of the present invention includes: a reduction processor that performs a reduction process on input image data, thereby generating reduced image data; a dark channel calculator that performs a calculation which determines a dark channel value in a local region which includes an interested pixel in a reduced image based on the reduced image data, performs the calculation throughout the reduced image by changing a position of the local region, and outputs a plurality of dark channel values obtained from the calculation as a plurality of first dark channel values; a map resolution enhancement processor that performs a process of enhancing resolution of a first dark channel map including the plurality of first dark channel values by using the reduced image as a guide image, thereby generating a second dark channel map including a plurality of second dark channel values; and a contrast corrector that performs a process of correcting contrast in the input image data on a basis of the second dark channel map and the reduced image data, thereby generating corrected image data.

An image processing device according to another aspect of the present invention includes: a reduction processor that performs a reduction process on input image data, thereby generating reduced image data; a dark channel calculator that performs a calculation which determines a dark channel value in a local region which includes an interested pixel in a reduced image based on the reduced image data, performs the calculation throughout the reduced image by changing a position of the local region, and outputs a plurality of dark channel values obtained from the calculation as a plurality of first dark channel values; and a contrast corrector that performs a process of correcting contrast in the input image data on a basis of a first dark channel map including the plurality of first dark channel values, thereby generating corrected image data.

An image processing method according to one aspect of the present invention includes: a reduction step of performing a reduction process on input image data, thereby generating reduced image data; a calculation step of performing a calculation which determines a dark channel value in a local region which includes an interested pixel in a reduced image based on the reduced image data, performing the calculation throughout the reduced image by changing a position of the local region, and outputting a plurality of dark channel values obtained from the calculation as a plurality of first dark channel values; a map resolution enhancement step of performing a process of enhancing resolution of a first dark channel map including the plurality of first dark channel values by using the reduced image as a guide image, thereby generating a second dark channel map including a plurality of second dark channel values; and a correction step of performing a process of correcting contrast in the input image data on a basis of the second dark channel map and the reduced image data, thereby generating corrected image data.

An image processing method according to another aspect of the present invention includes: a reduction step of performing a reduction process on input image data, thereby generating reduced image data; a calculation step of performing a calculation which determines a dark channel value in a local region which includes an interested pixel in a reduced image based on the reduced image data, performing the calculation throughout the reduced image by changing a position of the local region, and outputting a plurality of dark channel values obtained from the calculation as a plurality of first dark channel values; and a correction step of performing a process of correcting contrast in the input image data on a basis of a first dark channel map including the plurality of first dark channel values, thereby generating corrected image data.

### Effects of the Invention

According to the present invention, by performing a process of removing haze from a captured image based on image data generated by capturing an image with a camera, it is possible to generate corrected image data as image data of a haze-free image without the haze.

Further, according to the present invention, the dark channel value calculation which requires a large amount of computation is not performed with regard to captured image data directly but performed with regard to reduced image data, and thus the computation amount can be reduced. Therefore, the present invention is suitable for a device that performs in real time a process of removing haze from an image of which visibility is deteriorated due to the haze.

Furthermore, according to the present invention, a process of comparing image data of a plurality of frames is not performed, and the dark channel value calculation is performed with regard to the reduced image data. Therefore, storage capacity required for a frame memory can be reduced.

### BRIEF DESCRIPTION OF THE DRAWINGS

FIGS. 1(a) to 1(c) are diagrams showing a haze correction technique according to dark channel prior.

FIG. 2 is a block diagram schematically showing a configuration of an image processing device according to a first embodiment of the present invention.

FIG. 3(a) is a diagram schematically showing a method for calculating a dark channel value from captured image data (a comparison example); FIG. 3(b) is a diagram schematically showing a method for calculating a first dark channel value from reduced image data (the first embodiment).

FIG. 4(a) is a diagram schematically showing processing by a guided filter in the comparison example; FIG. 4(b) is a diagram schematically showing processing performed by a map resolution enhancement processor in the image processing device according to the first embodiment.

FIG. 5 is a block diagram schematically showing a configuration of an image processing device according to a second embodiment of the present invention.

FIG. 6 is a block diagram schematically showing a configuration of an image processing device according to a third embodiment of the present invention.

FIG. 7 is a block diagram schematically showing a configuration of a contrast corrector of an image processing device according to a fourth embodiment of the present invention.

FIGS. 8(a) and 8(b) are diagrams schematically showing processing performed by an airglow estimation unit in FIG. 7.

FIG. 9 is a block diagram schematically showing a configuration of an image processing device according to a fifth embodiment of the present invention.

FIG. 10 is a block diagram schematically showing a configuration of a contrast corrector in FIG. 9.

FIG. 11 is a block diagram schematically showing a configuration of an image processing device according to a sixth embodiment of the present invention.

FIG. 12 is a block diagram schematically showing a configuration of a contrast corrector in FIG. 11.

FIG. 13 is a flowchart showing an image processing method according to a seventh embodiment of the present invention.

FIG. 14 is a flowchart showing an image processing method according to an eighth embodiment of the present invention.

FIG. 15 is a flowchart showing an image processing method according to a ninth embodiment of the present invention.

FIG. 16 is a flowchart showing a contrast correction step in an image processing method according to a tenth embodiment of the present invention.

FIG. 17 is a flowchart showing an image processing method according to an eleventh embodiment of the present invention.

FIG. 18 is a flowchart showing a contrast correction step in the image processing method according to the eleventh embodiment.

FIG. 19 is a flowchart showing a contrast correction step in an image processing method according to a twelfth embodiment.

FIG. 20 is a hardware configuration diagram showing an image processing device according to a thirteenth embodiment.

FIG. 21 is a block diagram schematically showing a configuration of an image capture device to which the image processing device according to any of the first to sixth and thirteenth embodiments of the present invention is applied as an image processing section.

FIG. 22 is a block diagram schematically showing a configuration of an image recording/reproduction device to which the image processing device according to any of the first to sixth and thirteenth embodiments of the present invention is applied as an image processing section.

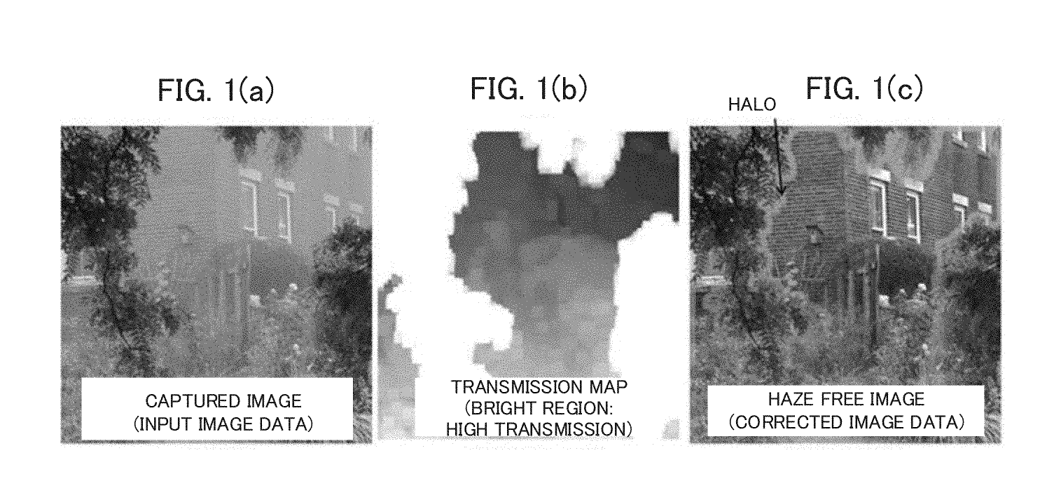

### MODE FOR CARRYING OUT THE INVENTION

### (1) First Embodiment

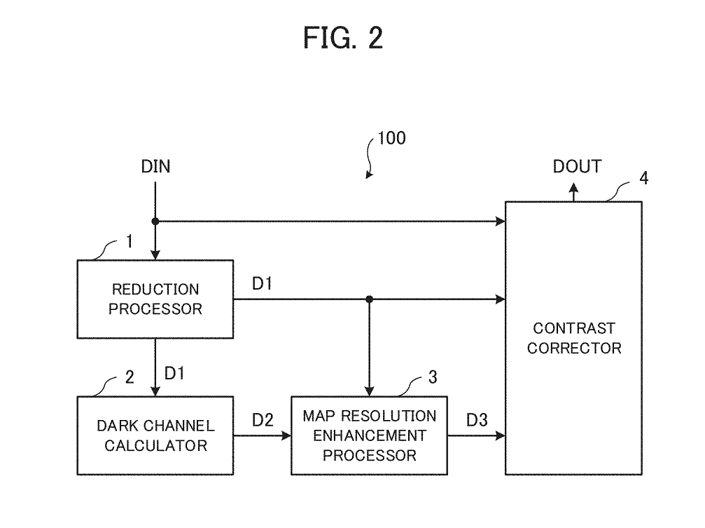

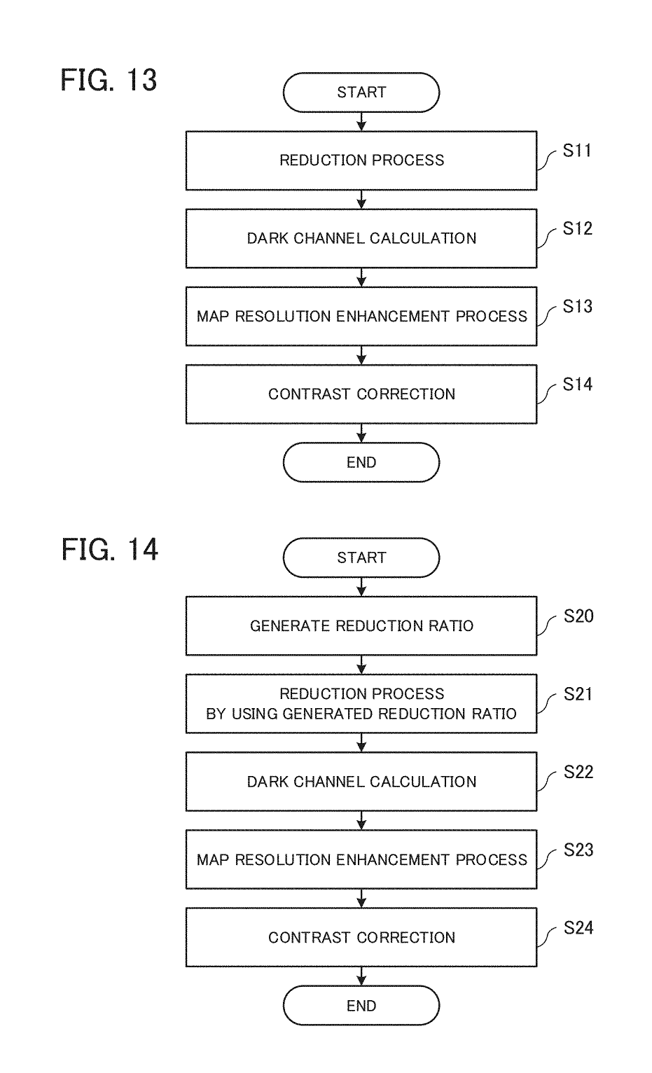

FIG. 2 is a block diagram schematically showing a configuration of an image processing device 100 according to a first embodiment of the present invention. The image processing device 100 according to the first embodiment performs a process of removing haze from a haze image which is an input image (captured image) based on input image data DIN generated by capturing an image with a camera, for example, thereby generating corrected image data DOUT as image data of an image without the haze (a haze-free image). The image processing device 100 is a device capable of carrying out an image processing method according to a seventh embodiment (FIG. 13) described later.

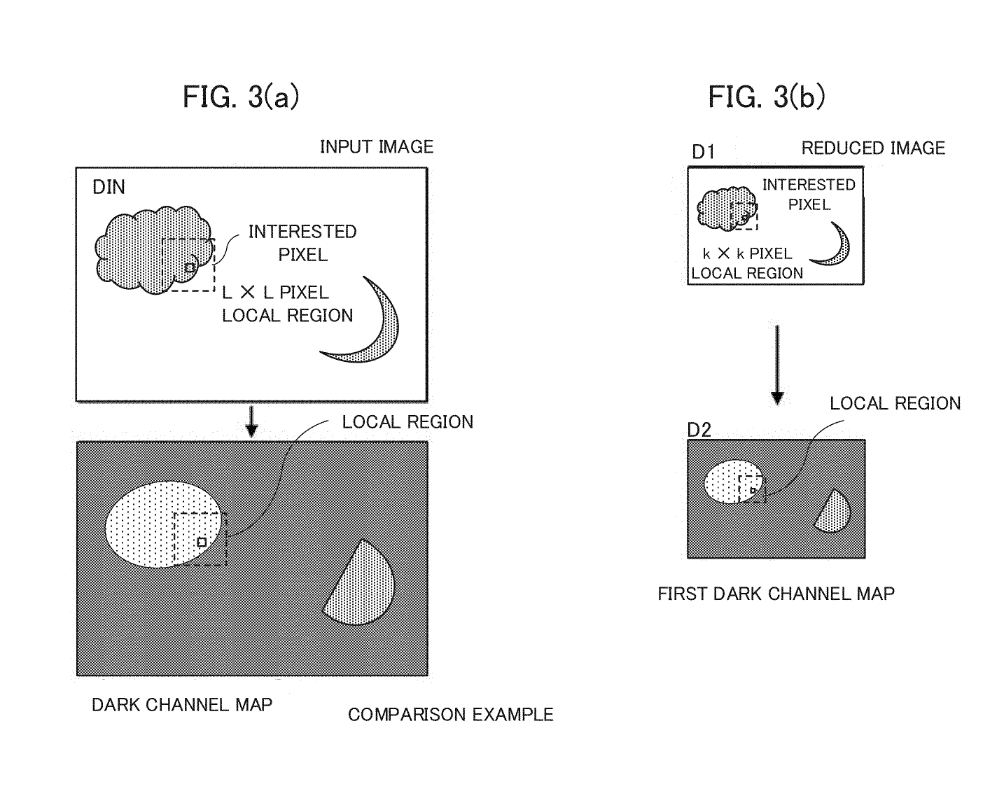

As shown in FIG. 2, the image processing device 100 according to the first embodiment includes: a reduction processor 1 that performs a reduction process on the input image data DIN, thereby generating reduced image data D1; and a dark channel calculator 2 that performs a calculation which determines a dark channel value in a local region (a region of k×k pixels shown in FIG. 3(b) described later) which includes an interested pixel in a reduced image based on the reduced image data D1, performs the calculation throughout the reduced image by changing the position of the interested pixel (i.e., by changing the position of the local region), and outputs a plurality of dark channel values obtained from the calculation as a plurality of first dark channel values (reduced dark channel values) D2. The image processing device 100 further includes a map resolution enhancement processor (dark channel map processor) 3 that performs a process of enhancing resolution of a first dark channel map constituted by the plurality of first dark channel values D2 by using the reduced image based on the reduced image data D1 as a guide image, thereby generating a second dark channel map constituted by a plurality of second dark channel values D3. Furthermore, the image processing device 100 includes a contrast corrector 4 that performs a process of correcting contrast in the input image data DIN on the basis of the second dark channel map and the reduced image data D1, thereby generating the corrected image data DOUT. In order to reduce processing loads of the dark channel calculation and the dark channel resolution enhancement process which require a large amount of computation and a frame memory, by reducing sizes of the input image data and the dark channel map, the image processing device 100 can achieve reduction in the computation amount and required storage capacity of the frame memory while maintaining a contrast correction effect.

Next, a function of the image processing device 100 will be described more in detail. The reduction processor 1 performs the reduction process on the input image data DIN, in order to reduce the size of the image (input image) based on the input image data DIN by using a reduction ratio of 1/N times (N is a value larger than 1). By the reduction process, the reduced image data D1 is generated from the input image data DIN. The reduction process by the reduction processor 1 is a process of thinning out pixels in the image based on the input image data DIN, for example. The reduction process by the reduction processor 1 may also be a process of averaging a plurality of pixels in the image based on the input image data DIN and generating pixels after the reduction process (e.g., a process according to a bilinear method, a process according to a bicubic method and the like). However, the method of the reduction process by the reduction processor 1 is not limited to the above examples.

The dark channel calculator 2 performs the calculation which determines the first dark channel value D2 in a local region which includes an interested pixel in the reduced image based on the reduced image data D1, and performs the calculation throughout the reduced image by changing the position of the local region in the reduced image. The dark channel calculator 2 outputs the plurality of first dark channel values D2 obtained from the calculation which determines the first dark channel value D2. As to the local region, a region of k×k pixels (pixels of k rows and k columns, where k is an integer not smaller than two.) including an interested pixel which is a certain single point in the reduced image based on the reduced image data D1 is defined as a local region of the interested pixel. However, the number of rows and the number of columns in the local region may also be different numbers from each other. The interested pixel may also be a center pixel of the local region.

More specifically, the dark channel calculator 2 determines a pixel value which is smallest in a local region (a smallest pixel value), with respect to each of color channels R, G and B. Next, the dark channel calculator 2 determines, in the same local region, the first dark channel value D2 which is a pixel value of a smallest value among a smallest pixel value of the R channel, a smallest pixel value of the G channel and a smallest pixel value of the B channel (a smallest pixel value in all the color channels). The dark channel calculator 2 determines the plurality of first dark channel values D2 throughout the reduced image by shifting the local region. The content of the process by the dark channel calculator 2 is the same as the process expressed by equation (2) shown above. The first dark channel value D2 is J_{dark} (X) which is the left side of equation (2), and the smallest pixel value in all the color channels in the local region is the right side of equation (2).

FIG. 3(a) is a diagram schematically showing a method for calculating a dark channel value in comparison examples; FIG. 3(b) is a diagram schematically showing a method for calculating the first dark channel value D2 by the dark channel calculator 2 in the image processing device 100 according to the first embodiment. In the methods described in Non-Patent Documents 1 and 2 (the comparison examples), as shown in an upper illustration of FIG. 3(a), a process of calculating a dark channel value in a local region of L×L pixels (L is an integer not smaller than two) in input image data DIN which has not undergone a reduction process is repeated by shifting the local region, and thus a dark channel map constituted by a plurality of dark channel values is generated, as shown in a lower illustration of FIG. 3(a). By contrast, the dark channel calculator 2 in the image processing device 100 according to the first embodiment performs the calculation which determines the first dark channel value D2 in a local region of k×k pixels which includes an interested pixel in the reduced image based on the reduced image data D1 generated by the reduction processor 1, as shown in an upper illustration of FIG. 3(b), performs the calculation throughout the reduced image by changing the position of the local region, and outputs as the first dark channel map constituted by the plurality of first dark channel values D2 obtained from the calculation which determines the first dark channel value D2, as shown in a lower illustration of FIG. 3(b).

In the first embodiment, at the time of setting the size (the number of rows and the number of columns) of the local region (e.g., k×k pixels) in the reduced image based on the reduced image data D1 shown in the upper illustration of FIG. 3(b), the size of the local region (e.g., L×L pixels) in the image based on the input image data DIN shown in the upper illustration of FIG. 3(a) is taken into consideration. For example, the size (the number of rows and the number of columns) of the local region (e.g., k×k pixels) in the reduced image based on the reduced image data D1 is set so that a ratio of the local region (a ratio of a viewing angle) to one picture in FIG. 3(b) substantially equals to a ratio of the local region (a ratio of a viewing angle) to one picture in FIG. 3(a). For this reason, the size of the local region of k×k pixels shown in FIG. 3(b) is smaller than the size of the local region of L×L pixels shown in FIG. 3(a). Thus, in the first embodiment, as shown in FIG. 3(b), since the size of the local region used for the calculation of the first dark channel value D2 is smaller in comparison to the case of the comparison examples shown in FIG. 3(a), it is possible to reduce a computation amount for calculating a dark channel value per interested pixel in the reduced image based on the reduced image data D1.

When the size of the local region in the comparison example shown in FIG. 3(a) is L×L pixels and the size of the local region in the reduced image based on the reduced image data D1 obtained by reducing the input image data DIN to 1/N times the input image data DIN is set to be k×k (k=L/N) (in the case of FIG. 3(b)), a computation amount required for the dark channel calculator 2 is obtained by multiplying the square of the reduction ratio of the image size (length reduction ratio), i.e., (1/N)² times, by the square of the reduction ratio of the size of the local region per interested pixel, i.e., (1/N)² times. Therefore, in the case of the first embodiment, it is possible to reduce the computation amount to (1/N)⁴ times the computation amount of the comparison examples at maximum reduction, in comparison to the comparison examples. Further, in the first embodiment, it is possible to reduce the storage capacity of the frame memory required for the calculation of the first dark channel value D2 to (1/N)² times as much as storage capacity required in the comparison examples.

It is not necessarily required that the reduction ratio of the local region size should be the same as the reduction ratio of the image 1/N in the reduction processor 1. For example, the reduction ratio of the local region may be a value larger than 1/N which is the reduction ratio of the image. That is, by setting the reduction ratio of the local region to be larger than 1/N to widen the viewing angle of the local region, it is possible to improve robustness of the dark channel calculation against noise. In particular, in a case where the reduction ratio of the-local region is set to a value larger than 1/N, the size of the local region increases and thus accuracy of dark channel value estimation and, in consequence, accuracy of haze density estimation can be improved.

The map resolution enhancement processor 3 performs the process of enhancing the resolution of the first dark channel map constituted by the plurality of first dark channel values D2 by using the reduced image based on the reduced image data D1 as the guide image, thereby generating the second dark channel map constituted by the plurality of second dark channel values D3. The resolution enhancement process performed by the map resolution enhancement processor 3 is a process by a Joint Bilateral Filter, a process by a guided filter and the like, for example. However, the map resolution enhancement process performed by the map resolution enhancement processor 3 is not limited to these.

When a corrected image (an image obtained after correction) q is determined from a correction target image p (an input image constituted by a haze image and noise), the joint bilateral filter and the guided filter perform filtering by using, as a guide image Hₕ, an image different from the correction target image p. Since the joint bilateral filter determines a weight coefficient for smoothing from an image H without noise, the joint bilateral filter is capable of removing noise while an edge is preserved with high accuracy in comparison to a Bilateral Filter.

An example of the process in a case where the guided filter is used in the map resolution enhancement processor 3 will be described below. A feature of the guided filter is to reduce a computation amount greatly by supposing a linear relationship between the guide image Hₕ and the corrected image q. Here, the small letter ‘h’ represents a pixel position.

By removing a noise component nh from a correction target image (an input image constituted by a haze image qₕ and the noise nₕ) pₕ, the haze image (a corrected image) qₕ can be obtained. This can be expressed in the following equation (8).

qₕ=pₕ−nₕ equation (8)

Further, the corrected image qₕ is made a linear function of the guide image Hₕ and can be expressed as the following equation (9).

qₕ=a×Hₕ+b equation (9)

By determining matrixes a, b in the following equation (10), the corrected image qₕ can be obtained.

$${min}_{( a , b )} {\sum }_{( x , y )} {( a ⋆ H ( x , y ) + b - p ( x , y ) )}^{2} + ɛ ⋆ {a}^{2} \qquad equation ( 10 )$$

Here, ε is a regularization constant, H(x,y) is Hₕ and p(x,y) is pₕ. Equation (10) is a publicly known equation.

In order to determine a pixel value of a certain interested pixel of coordinates (x, y) in the corrected image, it is necessary to set s×s pixels (s is an integer not less than two) including the interested pixel (surrounding the interested pixel) as a local region, and to determine values of the matrixes a, b from the respective local regions in the correction target image p (x, y) and the guide image H (x, y). In other words, for each interested pixel in the correction target image p (x, y), computation corresponding to the size of s×s pixels is required.

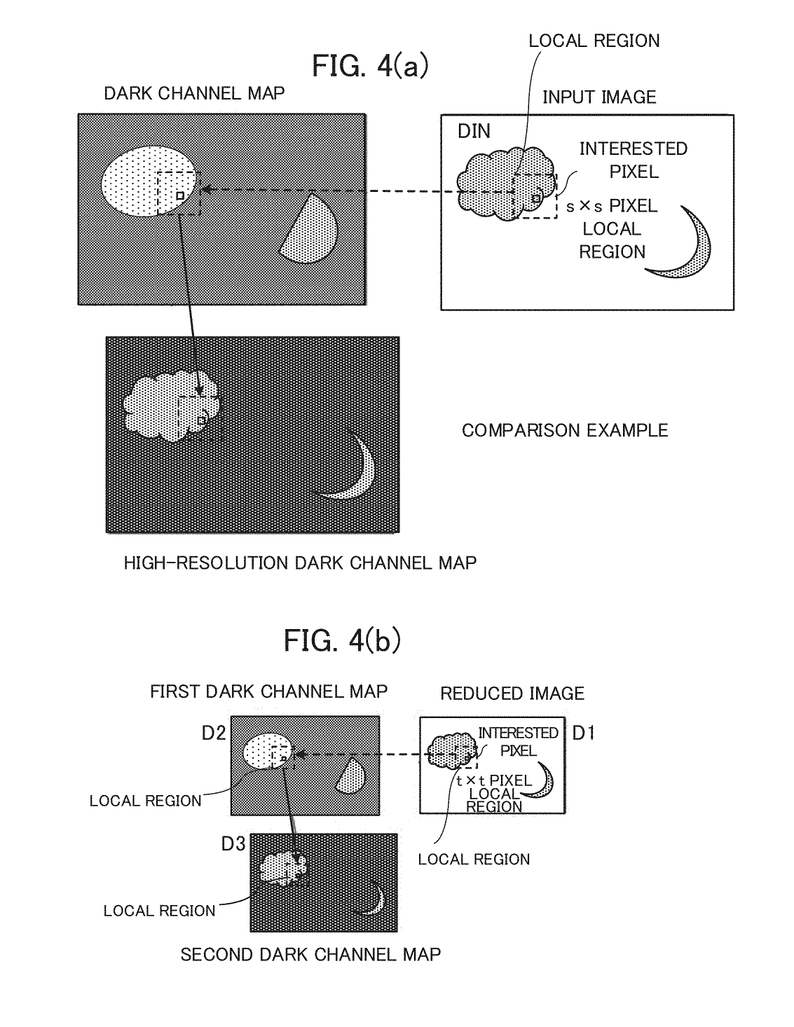

FIG. 4(a) is a diagram schematically showing a process by the guided filter shown in Non-Patent Document 2 as the comparison example; FIG. 4(b) is a diagram schematically showing a process performed by the map resolution enhancement processor 3 in the image processing device according to the first embodiment. In FIG. 4(a), by using s×s pixels (s is an integer not less than two) in the vicinity of an interested pixel as a local region, a pixel value of the interested pixel with respect to the second dark channel value D3 is calculated according to equation (7). By contrast, in the first embodiment in FIG. 4(b), at a time of setting the size of a local region (the number of rows and the number of columns) with respect to the first dark channel value D2, the size of a local region (e.g., s×s pixels) in the image based on the input image data DIN shown in FIG. 4(a) is taken into consideration. For example, the size (the number of rows and the number of columns) of a local region in the reduced image based on the reduced image data D1 (e.g., t×t pixels) is set so that a proportion of the local region to one picture (a proportion of a viewing angle) in FIG. 4(b) substantially equals to a proportion of the local region to one picture (a proportion of a viewing angle) in FIG. 4(a). For this reason, the size of the local region of t×t pixels shown in FIG. 4(b) is smaller than the size of the local region of s×s pixels shown in FIG. 4(a). Thus, in the first embodiment, as shown in FIG. 4(b), since the size of the local region used for calculating the first dark channel value D2 is smaller than that in the case of the comparison example shown in FIG. 4(a), it is possible to reduce a computation amount for calculating the first dark channel value D2 and a computation amount for calculating the second dark channel value D3 per interested pixel (a computation amount per pixel) in the reduced image based on the reduced image data D1.

A supposed case will be examined: in the case, the size of a local region including a certain interested pixel in a dark channel map is set to s×s pixels in the comparison example in FIG. 4(a), and the size of a local region including a certain interested pixel with respect to the first dark channel value D2 which is 1/N times scaled down in comparison to the input image data DIN is set to t×t pixels (t=s/N) in the first embodiment in FIG. 4(b). In this case, it is possible to reduce a computation amount required to the map resolution enhancement processor 3 to an amount obtained by multiplying the computation amount by (1/N)⁴, at maximum reduction, that is a reduction ratio obtained by multiplying (1/N)² times which is the square of the reduction ratio of the image 1/N and (1/N)² times which is the square of the reduction ratio of the local region 1/N per interested pixel. Moreover, it is also possible to reduce the storage capacity of the frame memory which should be provided in the image processing device 100 to a storage capacity obtained by multiplying the storage capacity by (1/N)².

Next, the contrast corrector 4 performs the process of correcting the contrast in the input image data DIN, on the basis of the second dark channel map constituted by the plurality of the second dark channel values D3 and the reduced. image data D1, thereby generating the corrected image data DOUT.

As shown in FIG. 4(b), in the contrast corrector 4, the second dark channel map constituted by the second dark channel values D3 has high resolution, however, its scale is reduced to a scale obtained by multiplying by 1/N in its length in comparison with the input image data DIN. For this reason, it is desirable to perform a process, in the contrast corrector 4, such as enlarging the second dark channel map constituted by the second dark channel values D3 (e.g., enlarging according to the bilinear method).

As described above, according to the image processing device 100 of the first embodiment, by performing the process of removing the haze from the image based on the input image data DIN, it is possible to generate the corrected image data DOUT as the image data of the haze-free image without the haze.

Further, according to the image processing device 100 of the first embodiment, since the dark channel value calculation which requires a large amount of computation is not performed directly on the input image data DIN but performed on the reduced image data D1, it is possible to reduce a computation amount for calculating the first dark channel value D2. Since the computation amount is thus reduced, the image processing device 100 of the first embodiment is suitable for a device performing, in real time, a process of reducing haze from an image in which visibility is deteriorated due to the haze. In the first embodiment, computation is added due to the reduction process, however, the increase in the computation amount due to the added computation is extremely small in comparison with the reduction in the computation amount in the calculation of the first dark channel value D2. Furthermore, in the first embodiment, it can be configured to select selecting a reduction by thinning that is highly effective in reduction in the computation amount with priority given to the computation amount to be reduced, or performing a highly-tolerant reduction process according to the bilinear method with priority given to tolerance to noise included in an image.

Moreover, according to the image processing device 100 of the first embodiment, the reduction process is not performed for the whole of the image, but performed for each local region which is a division from the whole of the image successively, and thus each of the dark channel calculator, the map resolution enhancement processor and the contrast corrector in stages following the reduction processor is capable of performing a process for each local region or a process for each pixel. Therefore, it is possible to reduce memory required throughout the process.

### (2) Second Embodiment

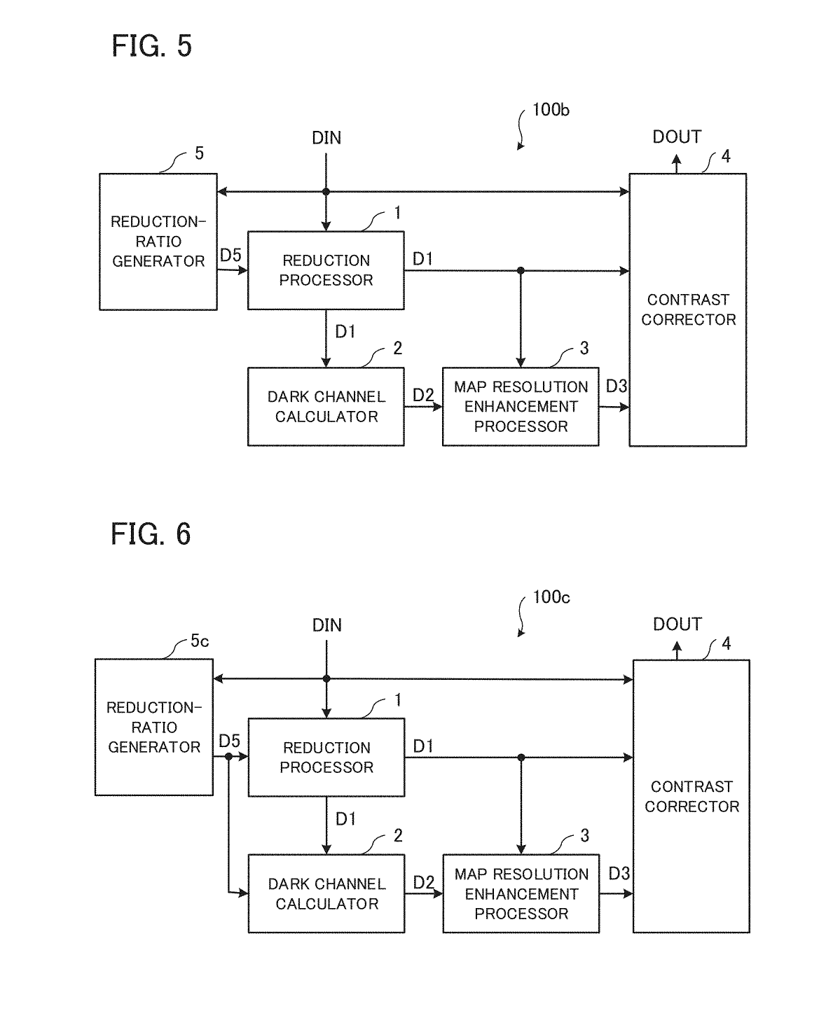

FIG. 5 is a block diagram schematically showing a configuration of an image processing device 100b according to a second embodiment of the present invention. In FIG. 5, components that are the same as or correspond to the components shown in FIG. 2 (the first embodiment) are assigned the same reference characters as the reference characters in FIG. 2. The image processing device 100b according to the second embodiment differs from the image processing device 100 according to the first embodiment in the following respects: that the image processing device 100b further includes a reduction-ratio generator 5 and that the reduction processor 1 performs a reduction process by using a reduction ratio 1/N generated by the reduction-ratio generator 5. The image processing device 100b is a device capable of carrying out an image processing method according to an eighth embodiment described later.

The reduction-ratio generator 5 carries out an analysis of the input image data DIN, determines the reduction ratio 1/N for the reduction process performed by the reduction processor 1 on the basis of a feature quantity obtained from the analysis, and outputs a reduction-ratio control signal D5 indicating the determined reduction ratio 1/N to the reduction processor 1. The feature quantity of the input image data DIN is the amount of high-frequency components in the input image data DIN (e.g., an average value of the amount of high-frequency components) which is obtained by performing a high-pass filtering process on the input image data DIN, for example. In the second embodiment, the reduction-ratio generator 5 sets a denominator N of the reduction-ratio control signal D5 to be larger, as the feature quantity of the input image data DIN becomes smaller, for example. A reason for this is that since the smaller the feature quantity is the less the high-frequency components in the image is, even if the denominator N of the reduction ratio is made large, an appropriate dark channel map can be generated and it is highly effective in reduction of a computation amount. Another reason is that if the denominator N of the reduction ratio is made large when the feature quantity is large, an appropriate dark channel map with high accuracy cannot be generated.

As described above, according to the image processing device 100b of the second embodiment, by performing a process of removing haze from the image based on the input image data DIN, it is possible to generate the corrected image data DOUT as image data of a haze-free image.

Further, according to the image processing device 100b of the second embodiment, the reduction processor 1 is capable of performing the reduction process by using the appropriate reduction ratio 1/N set in accordance with the feature quantity of the input image data DIN. Therefore, according to the image processing device 100b of the second embodiment, it is possible to appropriately reduce a computation amount in the dark channel calculator 2 and the map resolution enhancement processor 3 and it is also possible to appropriately reduce the storage capacity of the frame memory used for the dark channel calculation and the map resolution enhancement process.

In other respects, the second embodiment is the same as the first embodiment.

### (3) Third Embodiment

FIG. 6 is a block diagram schematically showing a configuration of an image processing device 100c according to a third embodiment of the present invention. In FIG. 6, components that are the same as or correspond to the components shown in FIG. 5 (the second embodiment) are assigned the same reference characters as the reference characters in FIG. 5. The image processing device 100c according to the third embodiment differs from the image processing device 100b according to the second embodiment in the following respects: that output from a reduction-ratio generator 5c is supplied not only to the reduction processor 1 but also to the dark channel calculator 2; and a calculation process by the dark channel calculator 2. The image processing device 100c is a device capable of carrying out an image processing method according to a ninth embodiment described later.

The reduction-ratio generator 5c carries out an analysis of the input image data DIN, determines a reduction ratio 1/N for the reduction process performed by the reduction processor 1 on the basis of a feature quantity obtained from the analysis, and outputs a reduction-ratio control signal D5 indicating the determined reduction ratio 1/N to the reduction processor 1 and the dark channel calculator 2. The feature quantity of the input image data DIN is the amount of high-frequency components of the input image data DIN (e.g., an average value) which is obtained by performing a high-pass filtering process on the input image data DIN, for example. The reduction processor 1 performs the reduction process by using the reduction ratio 1/N generated by the reduction-ratio generator 5c. In the third embodiment, the reduction-ratio generator 5c sets a denominator N of the reduction ratio control signal D5 to be larger, as the feature quantity of the input image data DIN becomes smaller, for example. On the basis of the.reduction ratio 1/N generated by the reduction-ratio generator 5c, the dark channel calculator 2 determines the size of a local region in the calculation which determines the first dark channel value D2. For example, supposing that the size of the local region is L×L pixels in a case where the reduction ratio is 1, the size of the local region in the reduced image based on the reduced image data D1 obtained by reducing the input image data DIN to 1/N times is set to be k×k pixels (k=L/N). A reason for this is that since the less the feature quantity is the less the high-frequency components in an image is, even if the denominator of the reduction ratio is made large, an appropriate dark channel value can be calculated and it is highly effective in reduction in a computation amount.

As described above, according to the image processing device 100c of the third embodiment, by performing the process of removing haze from the image based on the input image data DIN, it is possible to generate the corrected image data DOUT as image data of a haze-free image.

Further, according to the image processing device 100c of the third embodiment, the reduction processor 1 is capable of performing the reduction process by using the appropriate reduction ratio 1/N set in accordance with the feature quantity of the input image data DIN. Therefore, according to the image processing device 100c of the third embodiment, it is possible to appropriately reduce a computation amount in the dark channel calculator 2 and the map resolution enhancement processor 3, and it is also possible to appropriately reduce the storage capacity of the frame memory used for the dark channel calculation and the map resolution enhancement process.

In other respects, the third embodiment is the same as the second embodiment.

### (4) Fourth Embodiment

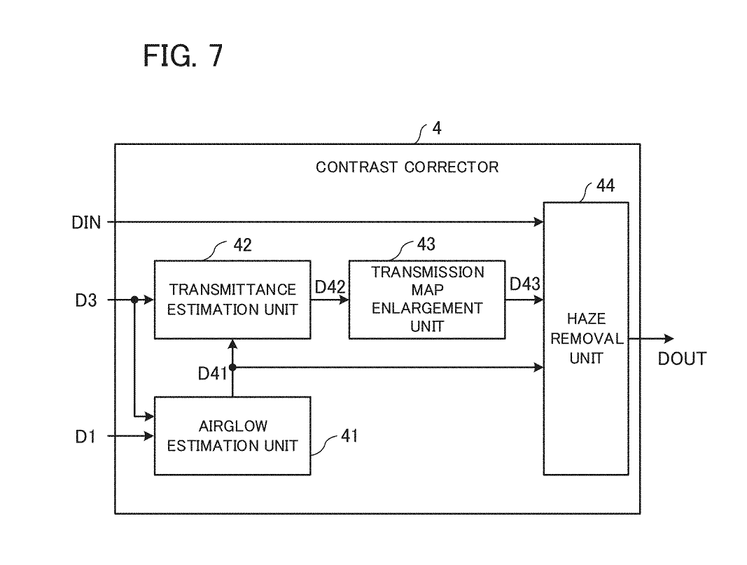

FIG. 7 is a diagram showing an example of a configuration of a contrast corrector 4 in an image processing device according to a fourth embodiment of the present invention. The contrast corrector 4 in the image processing device according to the fourth embodiment can be applied as the contrast corrector in any of the first to third embodiments. The image processing device according to the fourth embodiment is a device capable of carrying out an image processing method according to a tenth embodiment described later. In the description of the fourth embodiment, FIG. 2 is also referred to.

As shown in FIG. 7, the contrast corrector 4 includes: an airglow estimation unit 41 that estimates an airglow component D41 in the reduced image data D1, on the basis of the reduced image data D1 output from the reduction processor 1 and the second dark channel value D3 generated by the map resolution enhancement processor 3; and a transmittance estimation unit 42 that generates a transmission map D42 in the reduced image based on the reduced image data D1 on the basis of the airglow component D41 and the second dark channel value D3. The contrast corrector 4 further includes: a transmission map enlargement unit 43 that generates an enlarged transmission map D43 by performing a process of enlarging the transmission map D42; and a haze removal unit 44 that performs a haze correction process on the input image data DIN on the basis of the enlarged transmission map D43 and the airglow component D41, thereby generating the corrected image data DOUT.

The airglow estimation unit 41 estimates the airglow component D41 in the input image data DIN on the basis of the reduced image data D1 and the second dark channel value D3. The airglow component D41 can be estimated from a region with the thickest haze in the reduced image data D1. As the haze density becomes higher, the dark channel value increases; hence the airglow component D41 can be defined by using values of the respective color channels of the reduced image data D1 in a region where the second dark channel value (high-resolution dark channel value) D3 is the highest value.

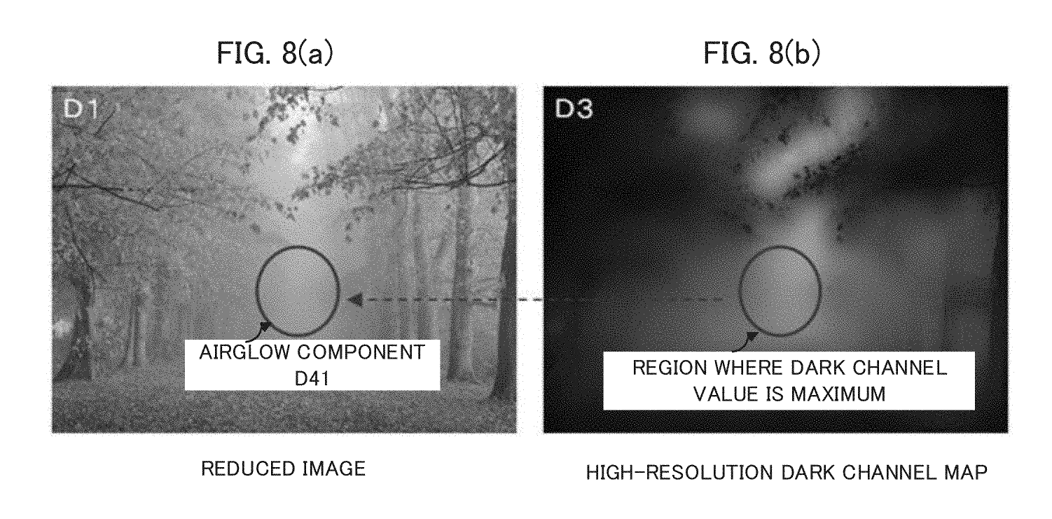

FIGS. 8(a) and 8(b) are diagrams schematically showing a process performed by the airglow estimation unit 41 in FIG. 7. FIG. 8(a) shows a picture cited from FIG. 5 of Non-Patent Document 1 with the addition of an explanation; FIG. 8(b) shows a picture obtained by performing image processing on the basis of FIG. 8(a). First, as shown in FIG. 8(b), from the second dark channel map constituted by the second dark channel values D3, an arbitrary number of pixels at which the dark channel value becomes maximum are extracted, a region which includes the extracted pixels is set as a maximum dark channel value region. Next, as shown in FIG. 8(a), by extracting pixel values in a region corresponding to the maximum dark channel value region from the reduced image data D1 and calculating an average value for each of the color channels R, G and B, the airglow components D41 in the respective color channels R, G and B are generated.

The transmittance estimation unit 42 estimates the transmission map D42, by using the airglow components D41 and the second dark channel value D3.

In equation (5), in a case where components A_{C} of the airglow components D41 in the respective color channels indicate similar values (substantially the same values), the airglow components A_{R}, A_{G} and A_{B} in the respective color channels R, G and B are A_{R}≈A_{G}≈A_{B}, and the left side of equation (5) can be expressed as the following equation (11).

$${min}_{C ∈ \{ R , G , B \}} ( {min}_{Y ∈ Ω ( X )} ( \frac{{I}_{C} ( Y )}{{A}_{C}} ) ) \approx \frac{{min}_{C ∈ \{ R , G , B \}} ( {min}_{Y ∈ Ω ( X )} ( {I}_{C} ( Y ) ) )}{{A}_{C}} \qquad equation ( 11 )$$

Accordingly, equation (5) can be expressed as the following equation (12).

$$\frac{{min}_{C ∈ \{ R , G , B \}} ( {min}_{Y ∈ Ω ( X )} ( {I}_{C} ( Y ) ) )}{{A}_{C}} = 1 - t ( X ) \qquad equation ( 12 )$$

Equation (12) indicates that the transmission map D42 constituted by a plurality of transmittances t (X) can be estimated from the second dark channel value D3 and the airglow component D41.

The fourth embodiment describes a case where it is supposed that components of the respective color channels in the airglow component D41 have similar values in order to omit a calculation in the transmittance estimation unit 42; however, the transmittance estimation unit 42 may calculate I_{C}/A_{C} with respect to each of the color channels R, G and B, determine dark channel values with respect to the respective color channels R, G and B, and generate a transmission map on the basis of the determined dark channel values. Such a configuration will be described in the fifth and sixth embodiments described later.

The transmission map enlargement unit 43 enlarges the transmission map D42 in accordance with the reduction ratio 1/N in the reduction processor 1 (enlarges with an enlargement ratio N, for example), and outputs the enlarged transmission map D43. The enlargement process is a process according to the bilinear method and a process according to the bicubic method, for example.

The haze removal unit 44 performs a correction process (haze removal process) of removing haze on the input image data DIN by using the enlarged transmission map D43, thereby generating the corrected image data DOUT.

By substituting the input image data DIN for ‘I(X)’, the airglow component D41 for ‘A’ and the enlarged transmission map D43 for ‘t’(X)′ in equation (7), J(X) that is the corrected image data DOUT can be determined.

As described above, according to the image processing device of the fourth embodiment, by performing the process of removing the haze from the image based on the input image data DIN, it is possible to generate the corrected image data DOUT as image data of a haze-free image.

Further, according to the image processing device of the fourth embodiment, it is possible to appropriately reduce a computation amount in the dark channel calculator 2 and the map resolution enhancement processor 3 and it is also possible to appropriately reduce the storage capacity of the frame memory used for the dark channel calculation and the map resolution enhancement process.

Furthermore, according to the image processing device of the fourth embodiment, by supposing that components of the respective color channels R, G and B of the airglow component D41 have the same value, it is possible to omit the dark channel value calculation with respect to each of the color channels R, G and B and to reduce a computation amount.

In other respects, the fourth embodiment is the same as the first embodiment.

### (5) Fifth Embodiment

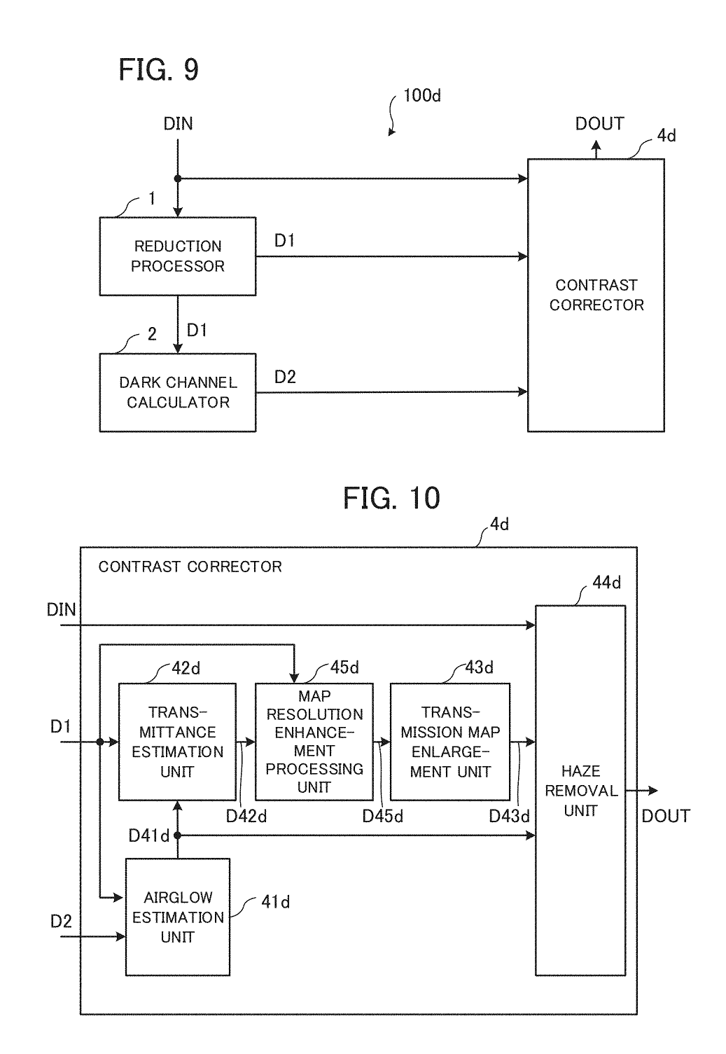

FIG. 9 is a block diagram schematically showing a configuration of an image processing device 100d according to a fifth embodiment of the present invention. In FIG. 9, components that are the same as or correspond to the components shown in FIG. 2 (the first embodiment) are assigned the same reference characters as the reference characters in FIG. 2. The image processing device 100d according to the fifth embodiment differs from the image processing device 100 according to the first embodiment in the following respects: not including the map resolution enhancement processor 3; and the configuration and functions of a contrast corrector 4d. The image processing device 100d according to the fifth embodiment is a device capable of carrying out an image processing method according to an eleventh embodiment described later. Note that the image processing device 100d according to the fifth embodiment may include the reduction-ratio generator 5 according to the second embodiment or the reduction-ratio generator 5c according to the third embodiment.

As shown in FIG. 9, the image processing device 100d according to the fifth embodiment includes: the reduction processor 1 that performs the reduction process on the input image data DIN, thereby generating the reduced image data D1; and the dark channel calculator 2 that performs the calculation which determines the dark channel value D2 in the local region which includes the interested pixel in the reduced image based on the reduced image data D1, performs the calculation throughout the reduced image by changing the position of the local region, and outputs the plurality of dark channel values obtained from the calculation as the first dark channel map constituted by the plurality of first dark channel values D2. The image processing device 100d further includes the contrast corrector 4d that performs, on the basis of the first dark channel map and the reduced image data D1, a process of correcting the contrast in the input image data DIN and thereby generates corrected image data DOUT.

FIG. 10 is a block diagram schematically showing a configuration of the contrast corrector 4d in FIG. 9. As shown in FIG. 10, the contrast corrector 4d includes: an airglow estimation unit 41d that estimates an airglow component D41d in the reduced image data D1, on the basis of the first dark channel map and the reduced image data D1; and a transmittance estimation unit 42d that generates a first transmission map D42d in the reduced image based on the reduced image data D1, on the basis of the airglow component D41d and the reduced image data D1. The contrast corrector 4d further includes: a map resolution enhancement processing unit (transmission map processing unit) 45d that performs a process of enhancing resolution of the first transmission map D42d by using the reduced image based on the reduced image data D1 as a guide image, thereby generating a second transmission map (high-resolution transmission map) D45d of which resolution is higher than the resolution of the first transmission map D42d; and a transmission map enlargement unit 43d that performs a process of enlarging the second transmission map D45d, thereby generating a third transmission map (enlarged transmission map) D43d. The contrast corrector 4d further includes a haze removal unit 44d that performs a haze removal process of correcting a pixel value of an input image, on the input image data DIN, on the basis of the third transmission map D43d and the airglow component D41d, thereby generating the corrected image data DOUT.

In the first to fourth embodiments, the resolution enhancement process is performed on the first dark channel map, whereas, in the fifth embodiment 5, the map resolution enhancement processing unit 45d in the contrast corrector 4d performs the resolution enhancement process on the first transmission map D42d.

In the fifth embodiment, the transmittance estimation unit 42d estimates the first transmission map D42d on the basis of the reduced image data D1 and the airglow component D41d. Specifically, by substituting a pixel value of the reduced image data D1 for I_{C} (Y) (Y denotes a pixel position in a local region) in equation (5) and substituting a pixel value of the airglow component D41d for A_{C}, a dark channel value that is a value on the left side of equation (5) is estimated. Since the estimated dark channel value equals to 1-t (X) (X denotes a pixel position) that is the right side of equation (5), the transmittance t(X) can be calculated.

The map resolution enhancement processing unit 45d generates the second transmission map D45d obtained by enhancing the resolution of the first transmission map D42d, by using the reduced image based on the reduced image data D1 as the guide image. The resolution enhancement process is a process by the joint bilateral filter, a process by the guided filter described in the first embodiment, and the like. However, the resolution enhancement process performed by the map resolution enhancement processing unit 45d is not limited to these.

The transmission map enlargement unit 43d enlarges the second transmission map D45d (enlarges by using the enlargement ratio N, for example) in accordance with the reduction ratio 1/N used in the reduction processor 1, thereby generating the third transmission map D43d. The enlargement process is a process according to the bilinear method, a process according to the bicubic method and the like, for example.

As described above, according to the image processing device 100d of the fifth embodiment, by performing the process of removing haze from the image based on the input image data DIN, it is possible to generate the corrected image data DOUT as image data of a haze-free image.

Further, according to the image processing device 100d of the fifth embodiment, it is possible to appropriately reduce a computation amount in the dark channel calculator 2 and the contrast corrector 4d, and it is also possible to appropriately reduce the storage capacity of the frame memory used for the dark channel calculation and the map resolution enhancement process.

Furthermore, the contrast corrector 4d in the image processing device 100d according to the fifth embodiment determines the airglow component D41d with respect to each of the color channels R, G and B, hence it is possible to perform an effective process, in a case where airglow is colored and it is desired to adjust white balance of the corrected image data DOUT. Therefore, according to the image processing device 100d, for example, in a case where the whole of the image is yellowish due to smog or the like, it is possible to generate the corrected image data DOUT in which yellow is suppressed.

In other respects, the fifth embodiment is the same as the first embodiment.

### (6) Sixth Embodiment

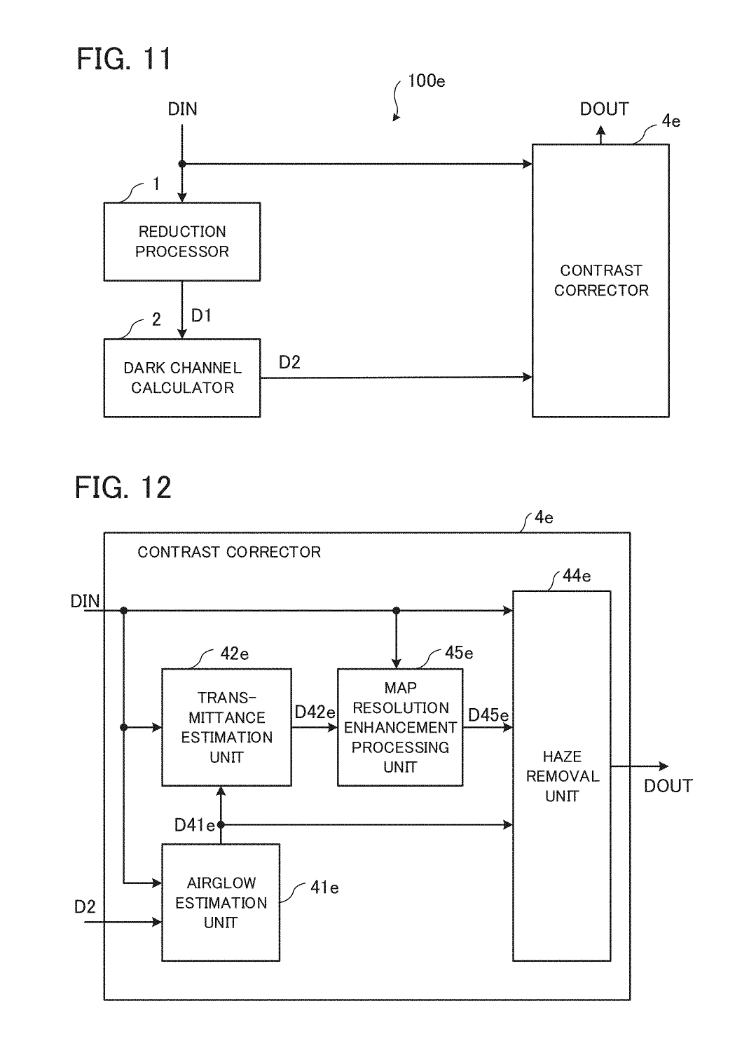

FIG. 11 is a block diagram schematically showing a configuration of an image processing device 100e according to a sixth embodiment of the present invention. In FIG. 11, components that are the same as or correspond to the components shown in FIG. 9 (the fifth embodiment) are assigned the same reference characters as the reference characters in FIG. 9. The image processing device 100e according to the sixth embodiment differs from the image processing device 100d shown in FIG. 9 in the following respects: that the reduced image data D1 is not supplied from the reduction processor 1 to a contrast corrector 4e; and the configuration and functions of the contrast corrector 4e. The image processing device 100e according to the sixth embodiment is a device capable of carrying out an image processing method according to a twelfth embodiment described later. Note that the image processing device 100e according to the sixth embodiment may include the reduction-ratio generator 5 in the second embodiment or the reduction-ratio generator 5c in the third embodiment.

As shown in FIG. 11, the image processing device 100e according to the sixth embodiment includes: the reduction processor 1 that performs the reduction process on the input image data DIN, thereby generating the reduced image data D1; and the dark channel calculator 2 that performs the calculation which determines the dark channel value D2 in the local region which includes the interested pixel in the reduced image based on the reduced image data D1, performs the calculation throughout the reduced image by changing the position of the local region, and outputs the plurality of dark channel values obtained from the calculation as the first dark channel map constituted by the plurality of first dark channel values D2. The image processing device 100e further includes the contrast corrector 4e that performs a process of correcting the contrast in the input image data DIN on the basis of the first dark channel map, thereby generating corrected image data DOUT.

FIG. 12 is a block diagram schematically showing a configuration of the contrast corrector 4e in FIG. 11. As shown in FIG. 12, the contrast corrector 4e includes: an airglow estimation unit 41e estimates an airglow component D41e in the input image data DIN on the basis of the input image data DIN and the first dark channel map; and a transmittance estimation unit 42d that generates a first transmission map D42e based on the input image data DIN, on the basis of the airglow component D41e and the input image data DIN. The contrast corrector 4e includes a map resolution enhancement processing unit (transmission map processing unit) 45e that performs a process of enhancing resolution of the first transmission map D42e by using the image based on the input image data DIN as a guide image, thereby generating a second transmission map (high-resolution transmission map) D45e of which resolution is higher than the resolution of the first transmission map D42e. The contrast corrector 4e further includes a haze removal unit 44e that performs a haze removal process of correcting a pixel value of the input image on the input image data DIN on the basis of the second transmission map D45e and the airglow component D41e, thereby generating the corrected image data DOUT.

In the first to fourth embodiments, the resolution enhancement process is performed on the first dark channel map, whereas, in the sixth embodiment, the map resolution enhancement processing unit 45e in the contrast corrector 4e performs the resolution enhancement process on the first transmission map D42e.

In the sixth embodiment, the transmittance estimation unit 42e estimates the first transmission map D42e on the basis of the input image data DIN and the airglow component D41e. Specifically, by substituting a pixel value of the reduced image data D1 for I_{C} (Y) in equation (5) and substituting a pixel value of the airglow component D41e for A_{C}, a dark channel value that is a value on the left side of equation (5) is estimated. Since the estimated dark channel value equals to 1-t(X) that is the right side of equation (5), the transmittance t (X) can be calculated.

The map resolution enhancement processor 45e generates the second transmission map (high-resolution transmission map) D45e obtained by enhancing the resolution of the first transmission map D42e by using the image based on the input image data DIN as the guide image. The resolution enhancement process is a process by the joint bilateral filter, a process by the guided filter, and the like, explained in the first embodiment. However, the resolution enhancement process performed by the map resolution enhancement processing unit 45e is not limited to these.

As described above, according to the image processing device 100e of the sixth embodiment, by performing the process for removing haze from the image based on the input image data DIN, it is possible to generate the corrected image data DOUT as image data of a haze-free image.

Further, according to the image processing device 100e of the sixth embodiment, it is possible to appropriately reduce a computation amount in the dark channel calculator 2 and the contrast corrector 4e, and it is also possible to appropriately reduce the storage capacity of the frame memory used for the dark channel calculation and the map resolution enhancement process.

Furthermore, the contrast corrector 4e in the image processing device 100e according to the sixth embodiment determines the airglow component D41e with respect to each of the color channels R, G and B, hence it is possible to perform an effective process in a case where the airglow is colored and it is desired to adjust white balance of the corrected image data DOUT. Therefore, according to the image processing device 100e, for example, in a case where the whole of the image is yellowish due to smog or the like, it is possible to generate the corrected image data DOUT in which yellow is suppressed. The image processing device 100e according to the sixth embodiment is effective in a case where it is desired to obtain the high-resolution second transmission map D45e while the white balance is adjusted and also to reduce a computation amount in the dark channel calculation.

In other respects, the sixth embodiment is the same as the fifth embodiment.

### (7) Seventh Embodiment

FIG. 13 is a flowchart showing an image processing method according to the seventh embodiment of the present invention. The image processing method according to the seventh embodiment is carried out by a processing device (e.g., a processing circuit, or a memory and a processor for executing a program stored in the memory). The image processing method according to the seventh embodiment can be carried out by the image processing device 100 according to the first embodiment.

As shown in FIG. 13, in the image processing method according to the seventh embodiment, the processing device first performs a process of reducing an input image based on input image data DIN (a reduction process of the input image data DIN), and generates reduced image data D1 regarding a reduced image (reduction step S11). The process in the step S11 corresponds to the process of the reduction processor 1 in the first embodiment (FIG. 2).

Next, the processing device performs a calculation which determines a dark channel value in a local region which includes an interested pixel in the reduced image based on the reduced image data D1, performs the calculation throughout the reduced image based on the reduced image data by changing the position of the local region, and generates a plurality of first dark channel values D2 which are a plurality of dark channel values obtained from the calculation (calculation step S12). The plurality of first dark channel values D2 constitutes a first dark channel map. The process in this step S12 corresponds to the process of the dark channel calculator 2 in the first embodiment (FIG. 2).

Next, the processing device performs a process of enhancing resolution of the first dark channel map by using the reduced image based on the reduced image data D1 as a guide image, thereby generating a second dark channel map (high-resolution dark channel map) constituted by a plurality of second dark channel values D3 (map resolution enhancement step S13). The process in this step S13 corresponds to the process of the map resolution enhancement processor 3 in the first embodiment (FIG. 2).

Next, the processing device performs a process of correcting contrast in the input image data DIN on the basis of the second dark channel map and the reduced image data D1, thereby generating corrected image data DOUT (correction step S14). The process in this step S14 corresponds to the process of the contrast corrector 4 in the first embodiment (FIG. 2).

As described above, according to the image processing method of the seventh embodiment, by performing the process of removing haze from the image based on the input image data DIN, it is possible to generate the corrected image data DOUT as image data of a haze-free image.

Further, according to the image processing method of the seventh embodiment, since the dark channel value calculation which requires a large amount of computation is not performed on the input image data DIN directly but performed on the reduced image data D1, it is possible to reduce a computation amount for calculating the first dark channel value D2. Furthermore, according to the image processing method of the seventh embodiment, it is possible to appropriately reduce storage capacity of a frame memory used for the dark channel calculation and the map resolution enhancement process.

### (8) Eighth Embodiment

FIG. 14 is a flowchart showing an image processing method according to the eighth embodiment. The image processing method shown in FIG. 14 is carried out by a processing device (e.g., a processing circuit, or a memory and a processor for executing a program stored in the memory). The image processing method according to the eighth embodiment can be carried out by the image processing device 100b according to the second embodiment.

In the image processing method shown in FIG. 14, the processing device first generates a reduction ratio 1/N on the basis of a feature quantity of input image data DIN (step S20). The process in this step corresponds to the process of the reduction-ratio generator 5 in the second embodiment (FIG. 5).

Next, the processing device performs a process of reducing an input image based on the input image data DIN (a reduction process of the input image data DIN) by using the reduction ratio 1/N, and generates reduced image data D1 regarding a reduced image (reduction step S21). The process in this step S21 corresponds to the process of the reduction processor 1 in the second embodiment (FIG. 5).

Next, the processing device performs a calculation which determines a dark channel value in a local region which includes an interested pixel in the reduced image based on the reduced image data D1, performs the calculation throughout the reduced image by changing the position of the local region, and generates a plurality of first dark channel values D2 which are a plurality of dark channel values obtained from the calculation (calculation step S22). The plurality of first dark channel values D2 constitute a first dark channel map. The process in this step S22 corresponds to the process of the dark channel calculator 2 in the second embodiment (FIG. 5).

Next, the processing device performs a process of enhancing resolution of the first dark channel map by using the reduced image as a guide image, thereby generating a second dark channel map (high-resolution dark channel map) constituted by a plurality of second dark channel values D3 (map resolution enhancement step S23). The process in this step S23 corresponds to the process of the map resolution enhancement processor 3 in the second embodiment (FIG. 5).

Next, the processing device performs a process of correcting contrast in the input image data DIN on the basis of the second dark channel map and the reduced image data D1, thereby generating corrected image data DOUT (correction step S24). The process in this step S24 corresponds to the process of the contrast corrector 4 in the second embodiment (FIG. 5).

As described above, according to the image processing method of the eighth embodiment, by performing the process of removing haze from the image based on the input image data DIN, it is possible to generate the corrected image data DOUT as image data of a haze-free image.

Further, according to the image processing method of the eighth embodiment, it is possible to perform the reduction process by using the appropriate reduction ratio 1/N which is set in accordance with the feature quantity of the input image data DIN. Therefore, according to the image processing method of the eighth embodiment, it is possible to appropriately reduce a computation amount and it is also possible to appropriately reduce storage capacity of a frame memory used for the dark channel calculation and the map resolution enhancement process.

### (9) Ninth Embodiment

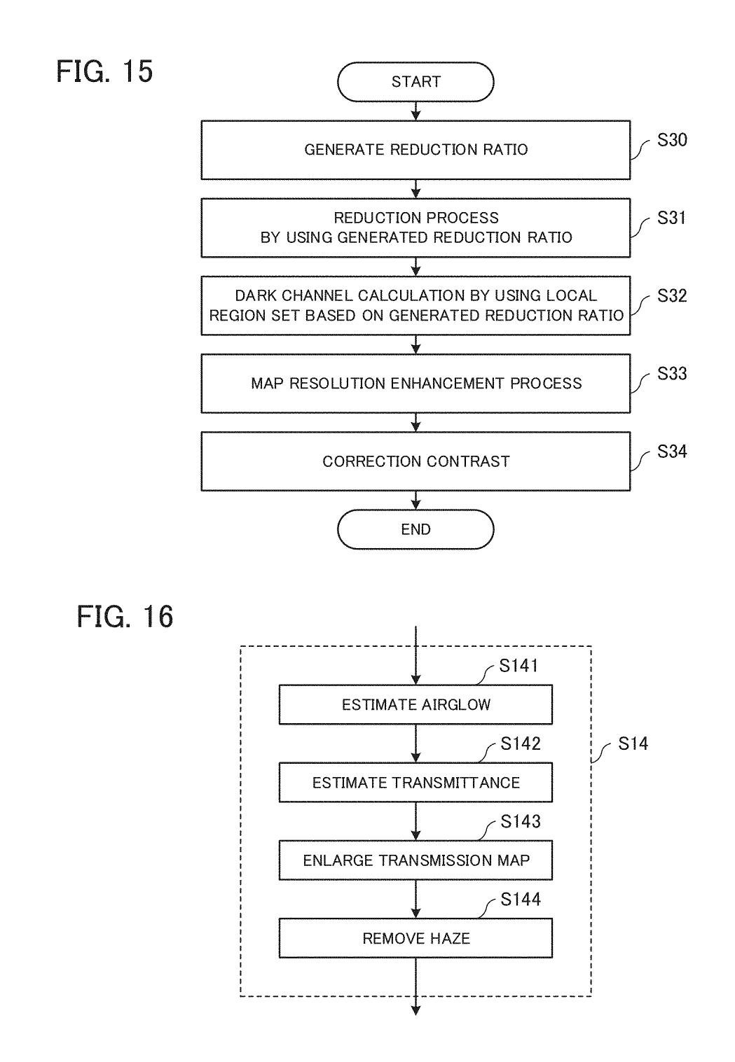

FIG. 15 is a flowchart showing an image processing method according to the ninth embodiment. The image processing method shown in FIG. 15 is carried out by a processing device (e.g., a processing circuit, or a memory and a processor for executing a program stored in the memory). The image processing method according to the ninth embodiment can be carried out by the image processing device 100c according to the third embodiment. A process in step S30 shown in FIG. 15 is the same as the process in step S20 shown in FIG. 14. The process in step S30 corresponds to the process of the reduction-ratio generator 5c in the third embodiment. A process in step S31 shown in FIG. 15 is the same as the process in step S21 shown in FIG. 14. The process in step S31 corresponds to the process of the reduction processor 1 in the third embodiment (FIG. 6).

Next, the processing device determines, on the basis of a reduction ratio 1/N, the size of a local region in calculation which determines a first dark channel value D2. Supposing that the size of the local region is L×L pixels in a case where no reduction process is performed, for example, the size of the local region in a reduced image based on reduced image data D1 obtained by reducing input image data DIN to 1/N times the input image data DIN is set to k×k pixels (k=L/N). The processing device performs a calculation which determines a dark channel value in the local region, performs the calculation throughout the reduced image by changing the position of the local region, and generates a plurality of first dark channel values D2 which are a plurality of dark channel values obtained from the calculation (calculation step S32). The plurality of first dark channel values D2 constitute a first dark channel map. The process in this step S32 corresponds to the process of the dark channel calculator 2 in the third embodiment (FIG. 6).

A process in step S33 shown in FIG. 15 is the same as the process in step S23 shown in FIG. 14. The process in step S33 corresponds to the process of the map resolution enhancement processor 3 in the third embodiment (FIG. 6).

A process in step S34 shown in FIG. 15 is the same as the process in step S24 shown in FIG. 14. The process in this step S34 corresponds to the process of the contrast corrector 4 in the third embodiment (FIG. 6).

As described above, according to the image processing method of the ninth embodiment, by performing a process of removing haze from the image based on the input image data DIN, it is possible to generate the corrected image data DOUT as image data of a haze-free image.

Further, according to the image processing method of the ninth embodiment, it is possible to perform the reduction process by using the appropriate reduction ratio 1/N set in accordance with a feature quantity of the input image data DIN. Thus, according to the image processing method of the ninth embodiment, it is possible to appropriately reduce a computation amount in the dark channel calculation (step S31) and the resolution enhancement process (step S32), and it is also possible to appropriately reduce storage capacity of a frame memory used for the dark channel calculation and the map resolution enhancement process.

### (10) Tenth Embodiment

FIG. 16 is a flowchart showing a contrast correction step in an image processing method according to the tenth embodiment. The process shown in FIG. 16 can be applied to step S14 in FIG. 13, step S24 in FIG. 14 and step S34 in FIG. 15. The image processing method shown in FIG. 16 is carried out by a processing device (e.g., a processing circuit, or a memory and a processor for executing a program stored in the memory). The contrast correction step in the image processing method according to the tenth embodiment can be performed by the contrast corrector 4 in the image processing device according to the fourth embodiment.

In step S14 shown in FIG. 16, the processing device first estimates an airglow component D41 in a reduced image based on reduced image data D1, on the basis of a second dark channel map constituted by a plurality of second dark channel values D3 and the reduced image data D1 (step S141). The process in this step corresponds to the process of the airglow estimation unit 41 in the fourth embodiment (FIG. 7).

Next, the processing device estimates a first transmittance on the basis of the second dark channel map constituted by the plurality of second dark channel values D3 and the airglow component D41, and generates a first transmission map D42 constituted by a plurality of first transmittances (step S142). The process in this step corresponds to the process of the transmittance estimation unit 42 in the fourth embodiment (FIG. 7).

Next, the processing device enlarges the first transmission map in accordance with a reduction ratio used for reduction in a reduction process (by using a reciprocal of the reduction ratio as an enlargement ratio, for example), and generates a second transmission map (enlarged transmission map) (step S143). The process in this step corresponds to the process of the transmission map enlargement unit 43 in the fourth embodiment (FIG. 7).

Next, the processing device performs, on the basis of the enlarged transmission map D43 and the airglow component D41, a process (haze removal process) of removing haze by correcting a pixel value of an image based on input image data DIN, corrects contrast of the input image, thereby generating corrected image data DOUT (step S144). The process in this step corresponds to the process of the haze removal unit 44 in the fourth embodiment (FIG. 7).

As described above, according to the image processing method of the tenth embodiment, by performing the process of removing haze from the image based on the input image data DIN, it is possible to generate the corrected image data DOUT as image data of a haze-free image.

Further, according to the image processing method of the tenth embodiment, it is possible to appropriately reduce a computation amount and it is also possible to appropriately reduce storage capacity of a frame memory used for the reduction process and the dark channel calculation.

### (11) Eleventh Embodiment

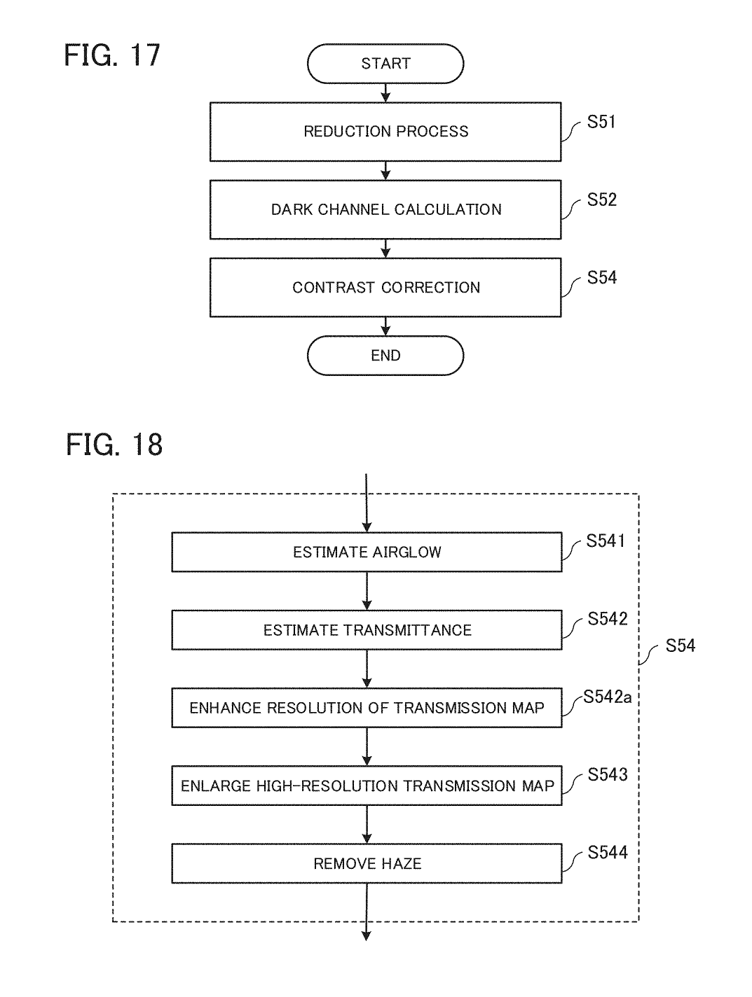

FIG. 17 is a flowchart showing an image processing method according to the eleventh embodiment. The image processing method shown in FIG. 17 can be carried out by the image processing device 100d according to the fifth embodiment (FIG. 9). The image processing method shown in FIG. 17 is carried out by a processing device (e.g., a processing circuit, or a memory and a processor for executing a program stored in the memory). The image processing method according to the eleventh embodiment can be carried out by the image processing device 100d according to the fifth embodiment.

In the image processing method shown in FIG. 17, the processing device first performs a reduction process on an input image based on input image data DIN, and generates reduced image data D1 regarding a reduced image (step S51). The process in this step S51 corresponds to the process of the reduction processor 1 in the fifth embodiment (FIG. 9).

Next, the processing device calculates a first dark channel value D2 in each local region with respect to the reduced image data D1, and generates a first dark channel map constituted by a plurality of first dark channel values D2 (step S52). The process in this step S52 corresponds to the process of the dark channel calculator 2 in the fifth embodiment (FIG. 9).

Next, the processing device performs, on the basis of the first dark channel map and the reduced image data D1, a process of correcting the contrast in the input image data DIN, thereby generating corrected image data DOUT (step S54). The process in this step S54 corresponds to the process of the contrast corrector 4d in the fifth embodiment (FIG. 9).

FIG. 18 is a flowchart showing the contrast correction step S54 in the image processing method according to the eleventh embodiment. Processes shown in FIG. 18 correspond to the processes of the contrast corrector 4d in FIG. 10.

In step S54 shown in FIG. 18, the processing device first estimates an airglow component D41d on the basis of the first dark channel map constituted by the plurality of first dark channel values D2 and the reduced image data D1 (step S541). The process in this step S541 corresponds to the process of the airglow estimation unit 41d in the fifth embodiment (FIG. 10).

Next, the processing device generates a first transmission map D42d in the reduced image on the basis of the reduced image data D1 and the airglow component D41d (step S542). The process in this step S542 corresponds to the process of the transmittance estimation unit 42d in the fifth embodiment (FIG. 10).

Next, the processing device performs a process of enhancing resolution of the first transmission map D42d by using the reduced image based on the reduced image data D1 as a guide image, thereby generating a second transmission map D45d of which resolution is higher than the resolution of the first transmission map (step S542a). The process in this step S542a corresponds to the process of the map resolution enhancement processing unit 45d in the fifth embodiment (FIG. 10).

Next, the processing device performs a process of enlarging the second transmission map D45d, thereby generating a third transmission map D43d (step S543). An enlargement ratio at the time can be set in accordance with a reduction ratio used for reduction in the reduction process (by using a reciprocal of the reduction ratio as the enlargement ratio, for example). The process in this step S543 corresponds to the process of the transmission map enlargement unit 43d in the fifth embodiment (FIG. 10).

Next, the processing device performs, on the basis of the third transmission map D43d and the airglow component D41d, a haze removal process of correcting a pixel value of the input image, on the input image data DIN, thereby generating the corrected image data DOUT (step S544). The process in this step S544 corresponds to the process of the haze removal unit 44d in the fifth embodiment (FIG. 10).

As described above, according to the image processing method of the eleventh embodiment, by performing the process of removing haze from the image based on the input image data DIN, it is possible to generate the corrected image data DOUT as image data of a haze-free image.

Further, according to the image processing method of the eleventh embodiment, it is possible to appropriately reduce a computation amount and it is also possible to appropriately reduce storage capacity of a frame memory used for the dark channel calculation and the map resolution enhancement process.

### (12) Twelfth Embodiment

The image processing method in FIG. 17 described in the eleventh embodiment may be content of processes which can be performed by the image processing device 100e according to the sixth embodiment (FIG. 11). In an image processing method in the twelfth embodiment, a processing device first performs a reduction process on an input image based on input image data DIN, and generates reduced image data D1 regarding a reduced image (step S51). This process in step S51 corresponds to the process of the reduction processor 1 in the sixth embodiment (FIG. 11).

Next, the processing device calculates a first dark channel value D2 in each local region with respect to the reduced image data D1, and generates a first dark channel map constituted by a plurality of first dark channel values D2 (step S52). The process in this step S52 corresponds to the process of the dark channel calculator 2 in the sixth embodiment (FIG. 11).

Next, the processing device performs a process of correcting contrast in the input image data DIN on the basis of the first dark channel map, thereby generating corrected image data DOUT (step S54). The process in this step S54 corresponds to the process of the contrast corrector 4e in the sixth embodiment (FIG. 11).

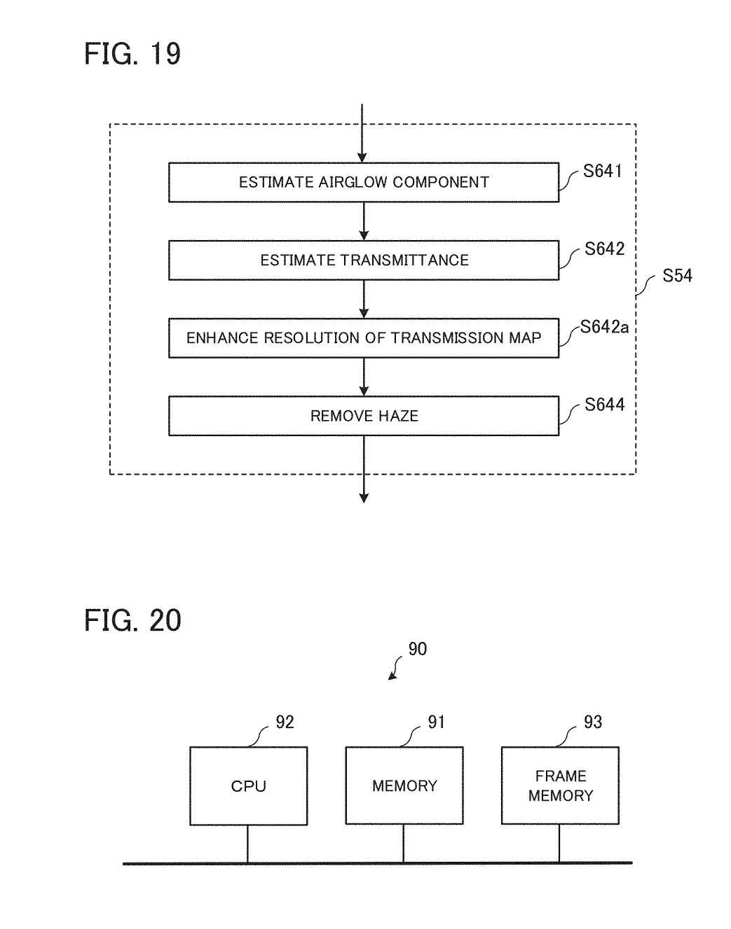

FIG. 19 is a flowchart showing the contrast correction step S54 in the image processing method according to the twelfth embodiment. Processes shown in FIG. 19 correspond to the processes of the contrast corrector 4e in FIG. 12.

In step S54 shown in FIG. 19, the processing device first estimates an airglow component D41, on the basis of the first dark channel map constituted by the plurality of first dark channel values D2 and the input image data DIN (step S641). The process in this step S641 corresponds to the process of the airglow estimation unit 41e in the sixth embodiment (FIG. 12).

Next, the processing device generates a first transmission map D42e in the reduced image on the basis of the input image data DIN and the airglow component D41e (step S642). The process in this step S642 corresponds to the process of the transmittance estimation unit 42e in the sixth embodiment (FIG. 12).

Next, the processing device performs a process of enhancing resolution of the first transmission map D42e by using the input image data DIN as a guide image, thereby generating a second transmission map (high-resolution transmission map) D45e of which resolution is higher than the resolution of the first transmission map D42e (step S642a). The process in this step S642a corresponds to the process of the map resolution enhancement processing unit 45e in the sixth embodiment.

Next, the processing device performs, on the input image data DIN, a haze removal process of correcting a pixel value of the input image, on the basis of the second transmission map D45e and the airglow component D41e, thereby generating the corrected image data DOUT (step S644). The process in this step S644 corresponds to the process of the haze removal unit 44e in the sixth embodiment (FIG. 12).

As described above, according to the image processing method of the twelfth embodiment, by performing the process of removing haze from the image based on the input image data DIN, it is possible to generate the corrected image data DOUT as image data of a haze-free image.

Further, according to the image processing method of the twelfth embodiment, it is possible to appropriately reduce a computation amount and it is also possible to appropriately reduce storage capacity of a frame memory used for the dark channel calculation and the map resolution enhancement process.

### (13) Thirteenth Embodiment

FIG. 20 is a hardware configuration diagram showing an image processing device according to a thirteenth embodiment of the present invention. The image processing device according to the thirteenth embodiment can achieve the image processing devices according to the first to sixth embodiments. The image processing device according to the thirteenth embodiment (a processing device 90) can be configured, as shown in FIG. 20, by a processing circuit such as an integrated circuit. The processing device 90 can be configured by a memory 91 and a CPU (Central Processing Unit) 92 capable of executing a program stored in the memory 91. The processing device 90 may also include a frame memory 93 formed by a semiconductor memory and the like. The CPU 92 is also called a central processing unit, an arithmetic unit, a microprocessor, a microcomputer, a processor or a DSP (Digital Signal Processor). The memory 91 is a nonvolatile or volatile semiconductor memory, such as a RAM (Random Access Memory), a ROM (Read Only Memory), a flash memory, an EPROM (Erasable Programmable Read Only Memory) and an EEPROM (Electrically Erasable Programmable Read-Only Memory), or the memory 91 is a magnetic disc, a flexible disc, an optical disc, a compact disc, a minidisc, a DVD (Digital Versatile Disc) or the like, for example.

The functions of the reduction processor 1, the dark channel calculator 2, the map resolution enhancement processor 3 and the contrast corrector 4 in the image processing device 100 according to the first embodiment (FIG. 2) can be achieved by the processing device 90. The respective functions of these components 1, 2, 3 and 4 can be achieved by the processing device 90, i.e., software, firmware or a combination of software and firmware. The software and firmware are written as a program and stored in the memory 91. The CPU 92 reads the program stored in the memory 91 and executes the read program, thereby achieving the respective functions of the components in the image processing device 100 according to the first embodiment (FIG. 2). In this case, the processing device 90 carries out the processes of steps S11 to S14 in FIG. 13.

In the same way, the functions of the reduction processor 1, the dark channel calculator 2, the map resolution enhancement processor 3, the contrast corrector 4 and the reduction ratio generator 5 in the image processing device 100b according to the second embodiment (FIG. 5) can be achieved by the processing device 90. The respective functions of these components 1, 2, 3, 4 and 5 can be achieved by the processing device 90, i.e., software, firmware or a combination of software and firmware. The CPU 92 reads the program stored in the memory 91 and executes the read program, thereby achieving the respective functions of the components in the image processing device 100b according to the second embodiment (FIG. 5). In this case, the processing device 90 carries out the processes of steps S20 to S24 in FIG. 14.

In the same way, the functions of the reduction processor 1, the dark channel calculator 2, the map resolution enhancement processor 3, the contrast corrector 4 and the reduction ratio generator 5c in the image processing device 100c according to the third embodiment (FIG. 6) can be achieved by the processing device 90. The respective functions of these components 1, 2, 3, 4 and 5c can be achieved by the processing device 90, i.e., software, firmware or a combination of software and firmware. The CPU 92 reads the program stored in the memory 91 and executes the read program, thereby achieving the respective functions of the components in the image processing device 100c according to the third embodiment (FIG. 6). In this case, the processing device 90 carries out the processes of steps S30 to S34 in FIG. 15.

In the same way, the functions of the airglow estimation unit 41, the transmittance estimation unit 42 and the transmission map enlargement unit 43 in the contrast corrector 4 in the image processing device according to the fourth embodiment (FIG. 7) can be achieved by the processing device 90. The respective functions of these components 41, 42 and 43 can be achieved by the processing device 90, i.e., software, firmware or a combination of software and firmware. The CPU 92 reads the program stored in the memory 91 and executes the read program, thereby achieving the respective functions of the components in the contrast corrector 4 in the image processing device according to the fourth embodiment. In this case, the processing device 90 performs the processes of steps S141 to S144 in FIG. 16.

In the same way, the functions of the reduction processor 1, the dark channel calculator 2 and the contrast corrector 4d in the image processing device 100d according to the fifth embodiment (FIG. 9 and FIG. 10) can be achieved by the processing device 90. The respective functions of these components 1, 2 and 4d can be achieved by the processing device 90, i.e., software, firmware or a combination of software and firmware. The CPU 92 reads the program stored in the memory 91 and executes the read program, thereby achieving the respective functions of the components in the image processing device 100d according to the fifth embodiment. In this case, the processing device 90 performs the processes of steps S51, S52 and S54 in FIG. 17. In step S54, the processes of steps S541, S542, S542a, S543 and S544 in FIG. 18 are performed.

In the same way, the functions of the reduction processor 1, the dark channel calculator 2 and the contrast corrector 4e in the image processing device 100e according to the sixth embodiment (FIG. 11 and FIG. 12) can be achieved by the processing device 90. The respective functions of these components 1, 2 and 4e can be achieved by the processing device 90, i.e., software, firmware or a combination of software and firmware. The CPU 92 reads the program stored in the memory 91 and executes the read program, thereby achieving the respective functions of the components in the image processing device 100e according to the sixth embodiment. In this case, the processing device 90 performs the processes of steps S51, S52 and S54 in FIG. 17. In step S54, the processes of steps S641, S642, S642a and S644 in FIG. 19 are performed.

### (14) Modification Example

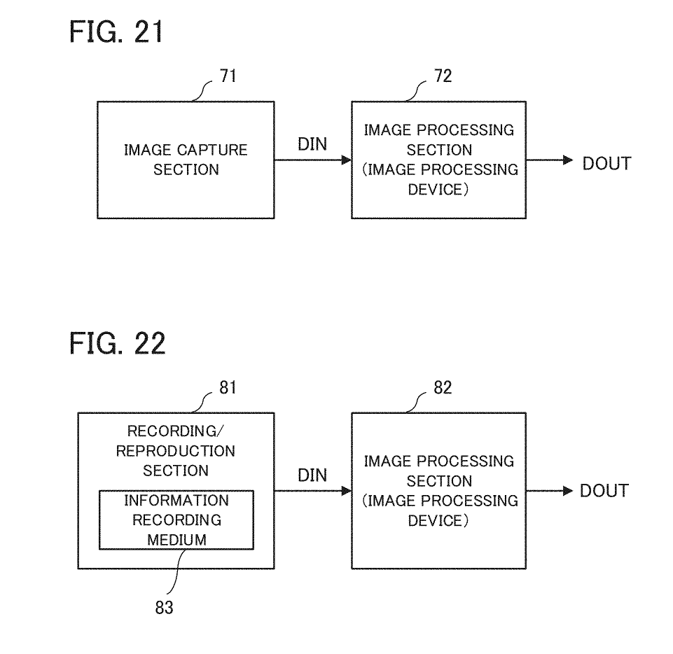

The image processing devices and image processing methods according to the first to thirteenth embodiments can be applied to an image capture device, such as a video camera, for example. FIG. 21 is a block diagram schematically showing a configuration of an image capture device to which the image processing device according to any of the first to sixth embodiments and the thirteenth embodiment of the present invention is applied as an image processing section 72. The image capture device to which the image processing device according to any of the first to sixth embodiments and the thirteenth embodiment is applied includes: an image capture section 71 that generates input image data DIN by capturing an image with a camera; and the image processing section 72 that has the same configuration and functions as the image processing device according to any of the first to sixth embodiments and the thirteenth embodiment. The image capture device to which the image processing method according to any of the seventh to twelfth embodiments is applied includes: the image capture section 71 that generates the input image data DIN; and the image processing section 72 that performs the image processing method according to any of the seventh to twelfth embodiments. Such an image capture device can output, in real time, corrected image data DOUT which allows a haze-free image to be displayed, even in a case where a haze image is captured.

Further, the image processing devices and the image processing methods according to the first to thirteenth embodiments can be applied to an image recording/reproduction device (e.g., a hard disk recorder, an optical disc recorder and the like). FIG. 22 is a block diagram schematically showing a configuration of an image recording/reproduction device to which the image processing device according to any of the first to sixth and thirteenth embodiments of the present invention is applied as an image processing section 82. The image recording/reproduction device to which the image processing device according to any of the first to sixth embodiments and the thirteenth embodiment is applied includes: a recording/reproduction section 81 that records image data in an information recording medium 83 and outputs the image data recorded in the information recording medium 83 as input image data DIN which is input to the image processing section 82 as the image processing device; and the image processing section 82 that performs image processing on the input image data DIN output from the recording/reproduction section 81 to generate corrected image data DOUT. The image processing section 82 has the same configuration and functions as the image processing device according to any of the first to sixth embodiments and the thirteenth embodiment. Alternatively, the image processing section 82 is configured so as to be able to carry out the image processing method according to any of the seventh and twelfth embodiments. Such an image recording/reproduction device is capable of outputting, at a time of reproduction, the corrected image data DOUT which allows a haze-free image to be displayed, even in a case where a haze image is recorded in the information recording medium 83.

Furthermore, the image processing devices and the image processing methods according to the first to thirteenth embodiments can be applied to an image display apparatus (e.g., a television, a personal computer, and the like) that displays on a display screen an image based on image data. The image display apparatus to which the image processing device according to any of the first to sixth embodiments and the thirteenth embodiment is applied includes: an image processing section that generates corrected image data DOUT from input image data DIN; and a display section that displays on a screen an image based on the corrected image data DOUT output from the image processing section. The image processing section has the same configuration and functions as the image processing device according to any of the first to sixth embodiments and the thirteenth embodiment. Alternatively, the image processing section is configured so as to be able to carry out the image processing method according to any of the seventh to twelfth embodiments. Such an image display apparatus is capable of displaying a haze-free image in real time, even in a case where a haze image is input as input image data DIN.

The present invention further includes a program for making a computer execute the processes in the image processing devices and the image processing methods according to the first to thirteenth embodiments, and a computer-readable recording medium in which the program is recorded.

### DESCRIPTION OF REFERENCE CHARACTERS

100, 100b, 100c, 100d, 100e image processing device; 1 reduction processor; 2 dark channel calculator; 3 map resolution enhancement processor (dark channel map processor); 4, 4d, 4e contrast corrector; 5, 5c reduction ratio generator; 41, 41d, 41e airglow estimation unit; 42, 42d, 42e transmittance estimation unit; 43, 43d transmission map enlargement unit; 44, 44d, 44e haze removal unit; 45, 45d, 45e map resolution enhancement processing unit (transmission map processing unit); 71 image capture section; 72, 82 image processing section; 81 recording/reproduction section; 83 information recording medium; 90 processing device; 91 memory; 92 CPU; 93 frame memory.

1-20. (canceled)

21. An image processing device comprising:
a reduction processor that performs a reduction process on input image data which is data of an input image, thereby generating reduced image data;
a haze feature quantity calculator that performs a calculation which determines a value of a haze feature quantity indicating density of haze in a local region which includes an interested pixel in a reduced image based on the reduced image data, performs the calculation throughout the reduced image by changing a position of the local region, and outputs a plurality of haze feature quantity values obtained from the calculation as a plurality of first haze feature quantity values;
a map resolution enhancement processor that performs a process of enhancing resolution of a first haze feature quantity map including the plurality of first haze feature quantity values by using the reduced image as a guide image, thereby generating a second haze feature quantity map including a plurality of second haze feature quantity values; and
a contrast corrector that performs a process of correcting contrast in the input image data on a basis of the second haze feature quantity map and the reduced image data, thereby generating corrected image data.

22. The image processing device according to claim 21, wherein the contrast corrector includes:
an airglow estimation unit that estimates an airglow component in the reduced image data on a basis of the second haze feature quantity map and the reduced image data;
a transmittance estimation unit that generates a first transmission map in the reduced image on a basis of the second haze feature quantity map and the airglow component;
a transmission map enlargement unit that performs a process of enlarging the first transmission map, thereby generating a second transmission map; and
a haze removal unit that performs, on the input image data, a haze removal process of correcting a pixel value of the input image based on the input image data on a basis of the second transmission map and the airglow component, thereby generating the corrected image data.

23. An image processing device comprising:
a reduction processor that performs a reduction process on input image data which is data of an input image, thereby generating reduced image data;
a haze feature quantity calculator that performs a calculation which determines a value of a haze feature quantity indicating density of haze in a local region which includes an interested pixel in a reduced image based on the reduced image data, performs the calculation throughout the reduced image by changing a position of the local region, and outputs a plurality of haze feature quantity values obtained from the calculation as a plurality of first haze feature quantity values; and
a contrast corrector that performs a process of correcting contrast in the input image data on a basis of a first dark channel map including the plurality of first haze feature quantity values, thereby generating corrected image data;
wherein the contrast corrector includes:
an airglow estimation unit that estimates an airglow component in the input image data on a basis of the first haze feature quantity map and the input image data;
a transmittance estimation unit that generates a first transmission map in the input image based on the input image data on a basis of the input image data and the airglow component;
a map resolution enhancement processing unit that performs a process of enhancing resolution of the first transmission map by using the input image based on the input image data as a guide image, thereby generating a second transmission map of which resolution is higher than the resolution of the first transmission map; and
a haze removal unit that performs, on the input image data, a haze removal process of correcting a pixel value of the input image based on the input image data on a basis of the second transmission map and the airglow component, thereby generating the corrected image data.

24. An image processing device comprising:
a reduction processor that performs a reduction process on input image data which is data of an input image, thereby generating reduced image data;
a haze feature quantity calculator that performs a calculation which determines a value of a haze feature quantity indicating density of haze in a local region which includes an interested pixel in a reduced image based on the reduced image data, performs the calculation throughout the reduced image by changing a position of the local region, and outputs a plurality of haze feature quantity values obtained from the calculation as a plurality of first haze feature quantity values; and
a contrast corrector that performs a process of correcting contrast in the input image data on a basis of a first dark channel map including the plurality of first haze feature quantity values, thereby generating corrected image data;
wherein the contrast corrector includes:
an airglow estimation unit that estimates an airglow component in the reduced image data on a basis of the first haze feature quantity map and the reduced image data;
a transmittance estimation unit that generates a first transmission map in the reduced image on a basis of the reduced image data and the airglow component;
a map resolution enhancement processing unit that performs a process of enhancing resolution of the first transmission map by using the reduced image as a guide image, thereby generating a second transmission map of which resolution is higher than the resolution of the first transmission map;
a transmission map enlargement unit that performs a process of enlarging the second transmission map, thereby generating a third transmission map; and
a haze removal unit that performs, on the input image data, a haze removal process of correcting a pixel value of the input image based on the input image data on a basis of the third transmission map and the airglow component, thereby generating the corrected image data.

25. The image processing device according to claim 21, further comprising a reduction ratio generator that generates a reduction ratio used in the reduction process so that a size of the reduced image becomes larger as a feature quantity obtained from the input image data becomes smaller.

26. The image processing device according to claim 25, wherein the haze feature quantity calculator determines a size of the local region in the calculation which determines the first haze feature quantity value, on a basis of the reduction ratio generated by the reduction ratio generator.

27. An image processing method comprising:
a reduction step of performing a reduction process on input image data which is data of an input image, thereby generating reduced image data;
a calculation step of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values;
a map resolution enhancement step of performing a process of enhancing resolution of a first haze feature quantity map including the plurality of first haze feature quantity values by using the reduced image as a guide image, thereby generating a second haze feature quantity map including a plurality of second haze feature quantity values; and
a correction step of performing a process of correcting contrast in the input image data on a basis of the second haze feature quantity map and the reduced image data, thereby generating corrected image data.

28. The image processing method according to claim 27, wherein the correction step includes:
an airglow estimation step of estimating an airglow component in the reduced image on a basis of the second haze feature quantity map and the reduced image data;
a transmittance estimation step of generating a first transmission map in the reduced image on a basis of the second haze feature quantity map and the airglow component;
a transmission map enlargement step of performing a process of enlarging the first transmission map, thereby generating a second transmission map; and
a haze removal step of performing, on the input image data, a haze removal process of correcting a pixel value of the input image based on the input image data on a basis of the second transmission map and the airglow component, thereby generating the corrected image data.

29. An image processing method comprising:
a reduction step of performing a reduction process on input image data which is data of an input image, thereby generating reduced image data;
a calculation step of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values; and
a correction step of performing a process of correcting contrast in the input image data on a basis of a first haze feature quantity map including the plurality of first haze feature quantity values, thereby generating corrected image data;
wherein the correction step includes:
an airglow estimation step of estimating an airglow component in the input image data on a basis of the first haze feature quantity map and the input image data;
a transmittance estimation step of generating a first transmission map in the input image based on the input image data on a basis of the input image data and the airglow component;
a map resolution enhancement step of performing a process of enhancing resolution of the first transmission map by using the input image based on the input image data as a guide image, thereby generating a second transmission map of which resolution is higher than the resolution of the first transmission map; and
a haze removal step of performing, on the input image data, a haze removal process of correcting a pixel value of the input image based on the input image data on a basis of the second transmission map and the airglow component, thereby generating the corrected image data.

30. An image processing method comprising:
a reduction step of performing a reduction process on input image data which is data of an input image, thereby generating reduced image data;
a calculation step of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values; and
a correction step of performing a process of correcting contrast in the input image data, on a basis of a first haze feature quantity map including the plurality of first haze feature quantity values, thereby generating corrected image data;
wherein the correction step includes:
an airglow estimation step of estimating an airglow component in the reduced image data on a basis of the first haze feature quantity map and the reduced image data;
a transmittance estimation step of generating a first transmission map in the reduced image on a basis of the reduced image data and the airglow component;
a map resolution enhancement step of performing a process of enhancing resolution of the first transmission map by using the reduced image as a guide image, thereby generating a second transmission map of which resolution is higher than the resolution of the first transmission map;
a map enlargement step of performing a process of enlarging the second transmission map, thereby generating a third transmission map; and
a haze removal step of performing, on the input image data, a haze removal process of correcting a pixel value of the input image based on the input image data on a basis of the third transmission map and the airglow component, thereby generating the corrected image data.

31. A program that makes a computer execute
a reduction process of performing a reduction process on input image data which is data of an input image, thereby generating reduced image data;
a calculation process of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values;
a map resolution enhancement process of performing a process of enhancing resolution of a first haze feature quantity map including the plurality of fist haze feature quantity values by using the reduced image as a guide image, thereby generating a second haze feature quantity map including a plurality of second haze feature quantity values; and
a correction process of performing a process of correcting contrast in the input image data on a basis of the second haze feature quantity map and the reduced image data, thereby generating corrected image data.

32. A program that makes a computer execute
a reduction process of performing a reduction process on input image data which is data of an input image, thereby generating reduced image data;
a calculation process of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values; and
a correction process of performing a process of correcting contrast in the input image data on a basis of a first haze feature quantity map including the plurality of first haze feature quantity values, thereby generating corrected image data;
wherein the correction process includes:
an airglow estimation process of estimating an airglow component in the input image data on a basis of the first haze feature quantity map and the input image data;
a transmittance estimation process of generating a first transmission map in the input image based on the input image data on a basis of the input image data and the airglow component;
a map resolution enhancement process of performing a process of enhancing resolution of the first transmission map by using the input image based on the input image data as a guide image, thereby generating a second transmission map of which resolution is higher than the resolution of the first transmission map; and
a haze removal process of performing, on the input image data, a haze removal process of correcting a pixel value of the input image based on the input image data on a basis of the second transmission map and the airglow component, thereby generating the corrected image data.

33. A computer-readable recording medium recording a program that makes a computer execute
a reduction process of performing a reduction process on input image data which is data of an input image, thereby generating reduced image data;
a calculation process of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values;
a map resolution enhancement process of performing a process of enhancing resolution of a first haze feature quantity map including the plurality of first haze feature quantity values by using the reduced image as a guide image, thereby generating a second haze feature quantity map including a plurality of second haze feature quantity values; and
a correction process of performing a process of correcting contrast in the input image data on a basis of the second haze feature quantity map and the reduced image data, thereby generating corrected image data.

34. A computer-readable recording medium recording a program that makes a computer execute
a reduction process of performing a reduction process on input image data which is data of an input image, thereby generating reduced image data;
a calculation process of performing a calculation which determines a value of a haze feature quantity indicating density of haze in a local region which includes an interested pixel in a reduced image based on the reduced image data, performing the calculation throughout the reduced image by changing a position of the local region, and outputting a plurality of haze feature quantity values obtained from the calculation as a plurality of first haze feature quantity values; and
a correction process of performing a process of correcting contrast in the input image data on a basis of a first haze feature quantity map including the plurality of first haze feature quantity values, thereby generating corrected image data;
wherein the correction process includes:
an airglow estimation process of estimating an airglow component in the input image data on a basis of the first haze feature quantity map and the input image data;
a transmittance estimation process of generating a first transmission map in the input image based on the input image data on a basis of the input image data and the airglow component;
a map resolution enhancement process of performing a process of enhancing resolution of the first transmission map by using the input image based on the input image data as a guide image, thereby generating a second transmission map of which resolution is higher than the resolution of the first transmission map; and
a haze removal process of performing, on the input image data, a haze removal process of correcting a pixel value of the input image based on the input image data on a basis of the second transmission map and the airglow component, thereby generating the corrected image data.

35. An image capture device comprising:
an image processing section that is the image processing device according to claim 21; and
an image capture section that generates input image data input to the image processing section.

36. An image recording/reproduction device comprising:
an image processing section that is the image processing device according to claim 21; and
a recording/reproduction section that outputs image data recorded in an information recording medium as input image data input to the image processing section.

37. The image processing device according to claim 21, wherein the haze feature quantity indicating the density of haze is a dark channel, and the haze feature quantity calculator is a dark channel calculator.

38. The image processing device according to claim 21, wherein the haze is at least one of phenomenons called aerosols including haze, fog, mist, snow, smoke, smog and dust.
